(19) United States
(12) Patent Application Publication
(10) Pub. No.: US 2016/0153766 A1
(43) Pub. Date: Jun. 2, 2016

(54) OPTICAL APPARATUS AND METHODS

(71) Applicants: Robert JONES, Cambridge (GB); Alfred NEWMAN, Cambridge (GB); Martin BROCK, Cambridge (GB); Dean Stuart GRIFFITHS, Cambridge (GB)

(72) Inventors: Robert JONES, Cambridge (GB); Alfred NEWMAN, Cambridge (GB); Martin BROCK, Cambridge (GB); Dean Stuart GRIFFITHS, Cambridge (GB)

(21) Appl. No.: 14/905,742

(22) PCT Filed: Jul. 17, 2014
(86) PCT No.: PCT/GB2014/052186

§ 371 Date: Jan. 15, 2016

(30) Foreign Application Priority Data
Jul. 17, 2013 (GB) 1312795.6
Jul. 17, 2013 (GB) 1312806.1

(51) Int. Cl. G01B 9/02

(52) U.S. Cl. CPC G01B 9/02094; G01B 9/02098

(57) ABSTRACT

An optical apparatus measures characteristics of a measurement target including an illumination portion, detection portion and processing portion. The illumination portion produces at least one pair of spatially separated areas of illumination for illuminating a measurement target to produce an associated light field. The light field produced by illumination of the measurement target includes a component corresponding to interference between the areas of illumination, illuminates a first site on the measurement target and illuminates a second site on the measurement target. The detection portion receives light from the measurement target, directs the received light onto a detector, and outputs signals from the detector dependent on the intensity of the detected light. The processing portion analyses the signals output by the detector to measure the characteristics of the measurement target.

The present invention relates to optical apparatus and associated methods. The invention has particular although not exclusive relevance to an interferometer for measuring any of a plurality of parameters (e.g. vibration amplitude/frequency, refractive index, surface profile etc.) of a measurement target in harsh environments in which there are typically a number of confounding factors.

Speckle pattern interferometry (SPI) uses interference characteristics of electromagnetic waves incident on a measurement target to measure the characteristics of that measurement target. In conventional techniques, an SPI sensor will typically illuminate a measurement target with a sample beam comprising laser light. The measurement target must have an optically rough surface so that when it is illuminated by the laser light an image comprising an associated speckle pattern is formed. A ‘reference’ beam is derived from the same laser beam as the sample beam and is superimposed on the image from the measurement target. The light from the measurement target and the light of the reference beam interfere to produce a corresponding interference speckle pattern, which changes with out-of-plane displacement of the measurement target as a result of changes in the phase of the light from the measurement target relative to that of the reference beam. The changes in the speckle pattern can therefore be monitored, recorded and analysed to measure static and dynamic displacements of the measurement target. The speckle pattern produced and analysed in such systems is a subjective speckle pattern which varies in dependence on viewing parameters such as, for example, lens aperture, position and/or the like.

Sheared beam interferometry (or sheared interferometry) is a technique in which a light wavefront is split (or ‘sheared’) into two images which overlap to cause interference with one another to provide a plurality of fringes which may be used to determine the characteristics of a measurement target. One example of sheared beam interferometry has been described previously for applications in speckle pattern interferometry (SPI), for example R Jones and C Wykes: Holographic and Speckle Interferometry, Cambridge Series in Modern Optics 6, CUP 1983, pp. 156-159. In this example light incident on a surface produces a speckle pattern image which is split, by a shearing interferometer, into two interfering images to produce an interference pattern that may be observed through the interferometer.

A specific configuration of common path shearing Interferometry based on an angled wedge illumination element is the subject of an earlier patent application by Cambridge Consultants (WO 03/012366A1, published 13 Feb. 2003).

More recently, double lateral shearing interferometry has been used for ophthalmic measurements of tear film topography: Alfred Dubra et al, 1 Mar. 2004/vol 48, No 7/Applied Optics: pp. 1191-1199.

Measurement of the rotation of optically rough objects using purely laser speckle (without a generated fringe field, or spatially controllable differential measurement) is the subject of a patent by Zeev Zalevsky (WO 09/013738).

However, the above techniques have a number of limitations which make it difficult, or impossible, for them to be used to measure precisely a full range of parameters associated with a measurement target (such as vibration amplitude/frequency, refractive index, surface profile etc.), with high phase resolution (i.e. typically of the order 10⁻³ radians), in the presence of common confounding factors including, for example, high levels of background vibration, temperature and atmospheric turbulence, and higher order surface motions. Any such confounding factor would normally prevent the operation of conventional interferometers and therefore make them unsuitable for many measurement environments.

Accordingly, preferred embodiments of the present invention aim to provide methods and apparatus which overcome or at least alleviate one or more of the above issues.

In one aspect the invention provides optical apparatus for measuring characteristics of a measurement target, the apparatus comprising an illumination portion and, detection portion and a processing portion: the illumination portion comprising: means for producing at least one pair of spatially separated areas of illumination for illuminating said measurement target to produce an associated light field from which said characteristics of said measurement target can be measured, wherein the areas of illumination are mutually coherent and are each provided via a substantially common path such that the light field produced by the illumination of the measurement target comprises: a plurality of components having an increased power at spatial frequencies corresponding to interference between said areas of illumination; wherein said means for producing at least one pair of spatially separated areas of illumination is operable to: illuminate a first site on the measurement target with at least one of said spatially separated areas of illumination; and illuminate a second site on the measurement target with at least one other of said spatially separated areas of illumination; the detection portion comprising: means for detecting light and for outputting signals dependent on the intensity of the detected light; means for receiving said light field from the measurement target resulting from said illumination of the measurement target with the at least one pair of said spatially separated areas of illumination, the light field resulting from each pair containing said component corresponding to interference between said areas of illumination; means for directing the received light field onto the light detecting means; the processing portion comprising: means for analysing said signals output by said detecting means to measure said characteristics of said measurement target, wherein said analysing means is operable to analyse said signals output by said detecting means, in the frequency domain, to determine changes in said components having an increased power and to measure a difference between a first phase of at least one of said areas of illumination and a second phase for another of said areas of illumination based on said determined changes in said components having an increased power.

In another aspect the invention provides illumination apparatus for use as said illumination portion of the optical apparatus, the illumination apparatus comprising: said means for producing at least one pair of spatially separated areas of illumination for use in measuring said characteristics of said measurement target, wherein the areas of illumination are mutually coherent and are each provided via a substantially common path.

In another aspect the invention provides detection apparatus for use as said detection portion, of the optical apparatus, the detection apparatus comprising: said means for detecting light and for outputting a signal dependent on the intensity of the detected light; said means for receiving a light field from the measurement target resulting from illumination of the measurement target with at least one of said spatially separated areas of illumination; and said means for directing the received light field onto the light detecting means.

In another aspect the invention provides signal processing apparatus for use as said processing portion, of the optical apparatus, the signal processing apparatus comprising said means for analysing said signals output by said detecting means to measure said characteristics of said measurement target.

In another aspect the invention provides a method performed by optical apparatus for measuring characteristics of a measurement target, the apparatus comprising an illumination portion and, detection portion and a processing portion, the method comprising: the illumination portion: producing at least one pair of spatially separated areas of illumination for illuminating said measurement target to produce an associated light field from which said characteristics of said measurement target can be measured, wherein the areas of illumination are mutually coherent and are each provided via a substantially common path such that the light field produced by the illumination of the measurement target comprises: a plurality of components having an increased power at spatial frequencies corresponding to interference between said areas of illumination; wherein said at least one pair of spatially separated areas of illumination: illuminates a first site on the measurement target with at least one of said spatially separated areas of illumination; and illuminates a second site on the measurement target with at least one other of said spatially separated areas of illumination; the detection portion: receiving said light field from the measurement target resulting from said illumination of the measurement target with the at least one pair of said spatially separated areas of illumination, the light field resulting from each pair containing at least said component corresponding to interference between said areas of illumination; directing the received light field onto light detecting means; detecting light at the detecting means and outputting signals dependent on the intensity of the detected light; the processing portion: analysing said signals output by said detecting means to measure said characteristics of said measurement target, wherein said analysing comprises analysing said signals output by said detection portion, in the frequency domain, to determine changes in said components having an increased power and to measure a difference between a first phase of at least one of said areas of illumination and a second phase for another of said areas of illumination based on said determined changes in said components having an increased power.

In another aspect the invention provides a method performed by illumination apparatus, the method comprising: producing at least one pair of spatially separated areas of illumination for illuminating a measurement target to produce an associated light field from which said characteristics of said measurement target can be measured, wherein the areas of illumination are mutually coherent and are each provided via a substantially common path such that the light field produced by the illumination of the measurement target comprises: a plurality of components having an increased power at spatial frequencies corresponding to interference between said areas of illumination; wherein said producing at least one pair of spatially separated areas of illumination comprises: illuminating a first site on the measurement target with at least one of said spatially separated areas of illumination; and illuminating a second site on the measurement target with at least one other of said spatially separated areas of illumination; wherein a change in said components having an increased power results in a corresponding change in a difference between a first phase of at least one of said areas of illumination and a second phase for another of said areas of illumination.

In another aspect the invention provides a method performed by detection apparatus for detecting a light field produced using the above method performed by illumination apparatus, the method performed by the detection apparatus comprising: receiving said light field from the measurement target resulting from said illumination of the measurement target with the at least one pair of said spatially separated areas of illumination, the light field resulting from each pair containing at least said plurality of components component having an increased power at spatial frequencies corresponding to interference between said areas of illumination.

In another aspect the invention provides a method performed by signal processing apparatus for processing signals output by as part of the above method performed by detection apparatus, the method performed by signal processing apparatus comprising: analysing said signals output by said detecting apparatus to measure said characteristics of said measurement target, wherein said analysing comprises analysing said signals output by said detection apparatus, in the frequency domain, to determine changes in said components having an increased power and to measure a difference between a first phase of at least one of said areas of illumination and a second phase for another of said areas of illumination based on said determined changes in said components having an increased power.

In one exemplary embodiment there is provided optical apparatus for measuring characteristics of a measurement target, the apparatus comprising an illumination portion and, detection portion and a processing portion: the illumination portion comprising: means for producing at least one pair of spatially separated areas of illumination for illuminating the measurement target to produce an associated light field from which the characteristics of the measurement target can be measured, wherein the areas of illumination are mutually coherent and are each provided via a substantially common path such that the light field produced by the illumination of the measurement target comprises: when the measurement target has an optically rough surface, a component associated with self-interference within at least one of the areas of illumination; and a component corresponding to interference between the areas of illumination which is separable from any component comprising interference associated with self-interference; the detection portion comprising: means for detecting light and for outputting signals dependent on the intensity of the detected light; means for receiving the light field from the measurement target resulting from the illumination of the measurement target with the at least one pair of the spatially separated areas of illumination, the light field resulting from each pair containing at least the component corresponding to interference between the areas of illumination; means for directing the received light field onto the light detecting means; the processing portion comprising: means for analysing the signals output by the detecting means to measure the characteristics of the measurement target.

The means for producing the at least one pair of spatially separated areas of illumination may comprise shearing optics for shearing an incoming beam of light into at least two sheared beams of mutually coherent light, each sheared beam representing a respective source of one of the spatially separated areas of illumination.

The optical apparatus may further comprise optics for transforming the at least two sheared beams into at least two parallel beams each parallel beam representing a respective source of one of the spatially separated areas of illumination.

The shearing optics may comprise a non-interferometric component for shearing the incoming beam.

The shearing optics may comprise a diffraction grating for shearing the incoming beam.

The light field may comprise a plurality components (e.g. in the form of diffraction fringes) having an increased power at spatial frequencies corresponding to the interference between the areas of illumination.

The analysing means may be operable to analyse the signals output by the detecting means, in the frequency domain, to determine changes in the components having an increased power and/or to measure a difference between a first phase of one of the at least one of the areas of illumination and a second phase for another of the areas of illumination based on, for example, the determined changes in the components having an increased power.

The analysing means may be operable to analyse the signals output by the detecting means, for example to measure characteristics of a surface of the measurement target associated with an effective difference between an optical path length for at least one of the areas of illumination and an optical path length for another of the areas of illumination.

The analysing means may be operable to analyse the signals output by the detecting means to measure characteristics comprising a rotation of the measurement target to cause the effective difference between an optical path length for at least one of the areas of illumination and an optical path length for another of the areas of illumination.

The illuminated measurement target may have an optically rough surface, the light field from the measurement target may comprise at least one component comprising self-interference associated with roughness of the optically rough surface (e.g. a speckle pattern), and the analysing means may be operable to discriminate between the component corresponding to interference between the areas of illumination and the component comprising self-interference associated with roughness of the optically rough surface, whereby to measure the characteristics of the measurement target.

The analysing means may be operable to analyse the self-interference associated with roughness of the optically rough surface for example to measure the characteristics of the measurement target.

The analysing means may be operable to analyse the self-interference associated with roughness of the optically rough surface to measure characteristics of the measurement target associated with a movement of the illuminated measurement target (e.g. a translational movement in the plane of the illumination).

The analysing means may be operable to analyse the self-interference associated with roughness of the optically rough surface to measure characteristics of the measurement target associated with a movement, of the illuminated measurement target, with components in either or both of two axial directions within the plane of an illuminated surface of the measurement target.

The analysing means may be operable to analyse the self-interference associated with roughness of the optically rough surface to measure characteristics of the measurement target associated with a rotational movement, of the illuminated measurement target, about an axis normal to the plane of the measurement surface based on measurements of differential translations at two separate locations.

The means for producing spatially separated areas of illumination may be operable to illuminate a measurement target with at least three spatially separated areas of illumination, wherein the at least three spatially separated areas of illumination are arranged to allow measurement for the measurement target to be performed for each of at least two axis of rotation.

The detection portion may comprise means for spatially filtering the light field associated with the at least three spatially separated areas of illumination to produce a light field associated with two of the spatially separated areas of illumination whereby to select an axis of rotation for which measurement is to be performed.

The analysing means may be operable to analyse the signals output by the detecting means to measure characteristics comprising a rotation of a surface of the measurement target about the selected axis.

The detecting means may comprise a point detector.

The optical apparatus may further comprise means for modulating phase of at least one of the spatially separated areas of illumination, using a known phase modulation, whereby to allow the analysing means to determine differences in phase associated with characteristics of the measurement target by analysing phased with reference to the known phase modulation.

The detecting means may comprise a one dimensional detector (e.g. a linear detector or linear array detector).

The detecting means may comprise a two dimensional detector.

The means for producing at least one pair of spatially separated areas of illumination may be operable to provide the spatially separated areas of illumination as two spots of illumination on a surface of a measurement target.

The means for producing at least one pair of spatially separated areas of illumination may be operable to provide the spatially separated areas of illumination as two lines of illumination.

The analysing means may be operable to analyse respective signals output by the detecting means for each of a plurality of different parts of the lines of illumination, whereby to measure characteristics of the measurement target at a plurality of different locations, each location being associated with a different respective part of the lines of illumination.

The means for producing at least one pair of spatially separated areas of illumination may comprise means for scanning the spatially separated areas of illumination across a measurement target (e.g. without moving the apparatus from one location to another).

The scanning means may comprise at least one mirror.

The scanning means may comprise at least one scanning lens (e.g. an F over theta lens).

The scanning means may comprise an optical flat.

The means for producing at least one pair of spatially separated areas of illumination may be operable to: illuminate a measurement site on a measurement target with at least one of the spatially separated areas of illumination; and/or illuminate a reference site on a measurement target with at least one other of the spatially separated areas of illumination.

The analysing means may be operable to analyse the signals output by the detecting means to measure characteristics of the measurement target associated with an effective difference between: an optical path length for the at least one area of illumination illuminating the measurement site; and an optical path length for the at least one other area of illumination illuminating the reference site.

The analysing means may be operable to analyse the signals output by the detecting means to measure characteristics, of the measurement target, associated with molecular surface binding at the measurement site.

The analysing means may be operable to analyse the signals output by the detecting means to measure characteristics, of the measurement target, associated with the occurrence of binding events associated with a change in optical path length.

The analysing means may be operable to analyse the signals output by the detecting means to measure characteristics, of the measurement target, associated with the occurrence of binding events associated with an increase in optical path length.

The analysing means may be operable to analyse the signals output by the detecting means to measure characteristics, of the measurement target, associated with the occurrence of binding events associated with a decrease in optical path length.

The means for producing at least one pair of spatially separated areas of illumination may be operable to illuminate at least two further reference sites on the measurement target with at least one further pair of spatially separated areas of illumination; wherein the analysing means may be operable to analyse the signals output by the detecting means for illumination incident on the at least two further reference sites to measure characteristics, of the measurement target, associated with rotation of the measurement target; and wherein the analysing means may be operable to use the measured characteristics associated with rotation of the measurement target to mitigate the effect of the rotation the measures characteristics associated with molecular surface binding.

The optical apparatus may further comprise means for inducing surface plasmon resonance while performing the measurement.

The measurement target may be located in an optically transparent medium (e.g. a medium having a refractive index greater than or equal to 1) and the illumination and detection portions may be provided on either side of the optically transparent medium.

The measurement target may be located in an optically transparent medium (e.g. a medium having a refractive index greater than or equal to 1) and the illumination and detection portions may be provided on the same side of the optically transparent medium.

The measurement target may be optically transparent having a refractive index that may be different to the refractive index of the transparent medium.

The analysing means may be operable to measure characteristics of the measurement target based on differences in phase associated with differences in the refractive indexes.

The analysing means may be operable to measure characteristics of a measurement target comprising a particle flowing in the transparent medium, past the areas of illumination, the characteristics comprising a size of the particle.

The analysing means may be operable to measure characteristics of said particle, when said particle is flowing within a region of said transparent medium, wherein said region may be a region of focus for a plurality of beams within said transparent medium, each beam representing a respective source of one of said spatially separated areas of illumination.

The measurement target may comprise part of said transparent medium having a characteristic (e.g. refractive index) that varies with respect to a corresponding characteristic of another part of said transparent medium. The analysing means may be operable to measure said characteristic that varies with respect to a corresponding characteristic of another part of said transparent medium, wherein said part of said transparent medium having a characteristic that varies with respect to a corresponding characteristic of another part of said transparent medium region may be part of a region of focus for a plurality of beams within said transparent medium, each beam representing a respective source of one of said spatially separated areas of illumination.

In one exemplary embodiment there is provided illumination apparatus for use as the illumination portion of the optical apparatus, the illumination apparatus comprising: the means for producing at least one pair of spatially separated areas of illumination for use in measuring the characteristics of the measurement target, wherein the areas of illumination may be mutually coherent and may each be provided via a substantially common path.

In one exemplary embodiment there is provided detection apparatus for use as the detection portion, of the optical apparatus, the detection apparatus comprising: the means for detecting light and for outputting a signal dependent on the intensity of the detected light; the means for receiving a light field from the measurement target resulting from illumination of the measurement target with at least one of the spatially separated areas of illumination; and/or the means for directing the received light field onto the light detecting means.

In one exemplary embodiment there is provided signal processing apparatus for use as said processing portion, of the optical apparatus, the signal processing apparatus comprising said means for analysing said signals output by said detecting means to measure said characteristics of said measurement target.

In one exemplary embodiment there is provided a method performed by optical apparatus for measuring characteristics of a measurement target, the apparatus comprising an illumination portion and, detection portion and a processing portion, the method comprising: the illumination portion: producing at least one pair of spatially separated areas of illumination for illuminating a surface of said measurement target to produce an associated light field from which said characteristics of said measurement target can be measured, wherein the areas of illumination are mutually coherent and are each provided via a substantially common path such that the light field produced by the illumination of the surface of the measurement target comprises: when said surface of the measurement target is optically rough, a component associated with self-interference within at least one of said areas of illumination; and a component corresponding to interference between said areas of illumination which is separable from any component comprising interference associated with self-interference; the detection portion: receiving said light field from the measurement target resulting from said illumination of the measurement target with the at least one pair of said spatially separated areas of illumination, the light field resulting from each pair containing at least said component corresponding to interference between said areas of illumination; directing the received light field onto light detecting means; detecting light at the detecting means and outputting signals dependent on the intensity of the detected light; the processing portion: analysing said signals output by said detecting means to measure said characteristics of said measurement target.

In one exemplary embodiment there is provided a method performed by illumination apparatus, the method comprising: producing at least one pair of spatially separated areas of illumination for illuminating a surface of a measurement target to produce an associated light field from which said characteristics of said measurement target can be measured, wherein the areas of illumination are mutually coherent and are each provided via a substantially common path such that the light field produced by the illumination of the surface of the measurement target comprises: when said surface of the measurement target is optically rough, a component associated with self-interference within at least one of said areas of illumination; and a component corresponding to interference between said areas of illumination which is separable from any component comprising interference associated with self-interference.

In one exemplary embodiment there is provided a method performed by detection apparatus for detecting a light field produced using the method performed by the illumination apparatus, the method performed by the detection apparatus comprising: receiving said light field from the measurement target resulting from said illumination of the measurement target with the at least one pair of said spatially separated areas of illumination, the light field resulting from each pair containing at least said component corresponding to interference between said areas of illumination.

In one exemplary embodiment there is provided a method performed by signal processing apparatus for processing signals output as part of the method performed by the detection apparatus, the method performed by the signal processing apparatus comprising: analysing said signals output by said detecting means to measure said characteristics of said measurement target.

Aspects of the invention are recited in the appended independent claims.

Specific areas of application described in detail in this document are remote motion measurement, and molecular binding detection.

Each feature disclosed in this specification (which term includes the claims) and/or shown in the drawings may be incorporated in the invention independently (or in combination with) any other disclosed and/or illustrated features. In particular but without limitation the features of any of the claims dependent from a particular independent claim may be introduced into that independent claim in any combination or individually.

Embodiments of the invention will now be described by way of example only with reference to the attached figures in which:

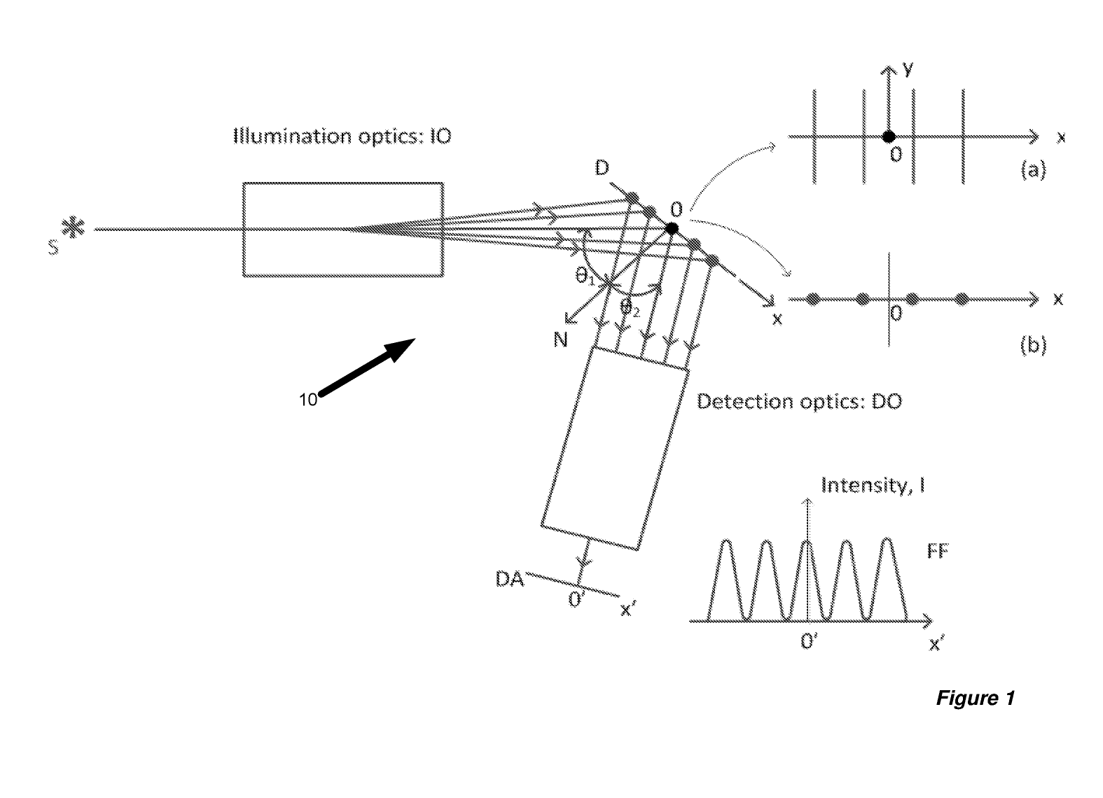

FIG. 1 show a general configuration of exemplary interferometer apparatus;

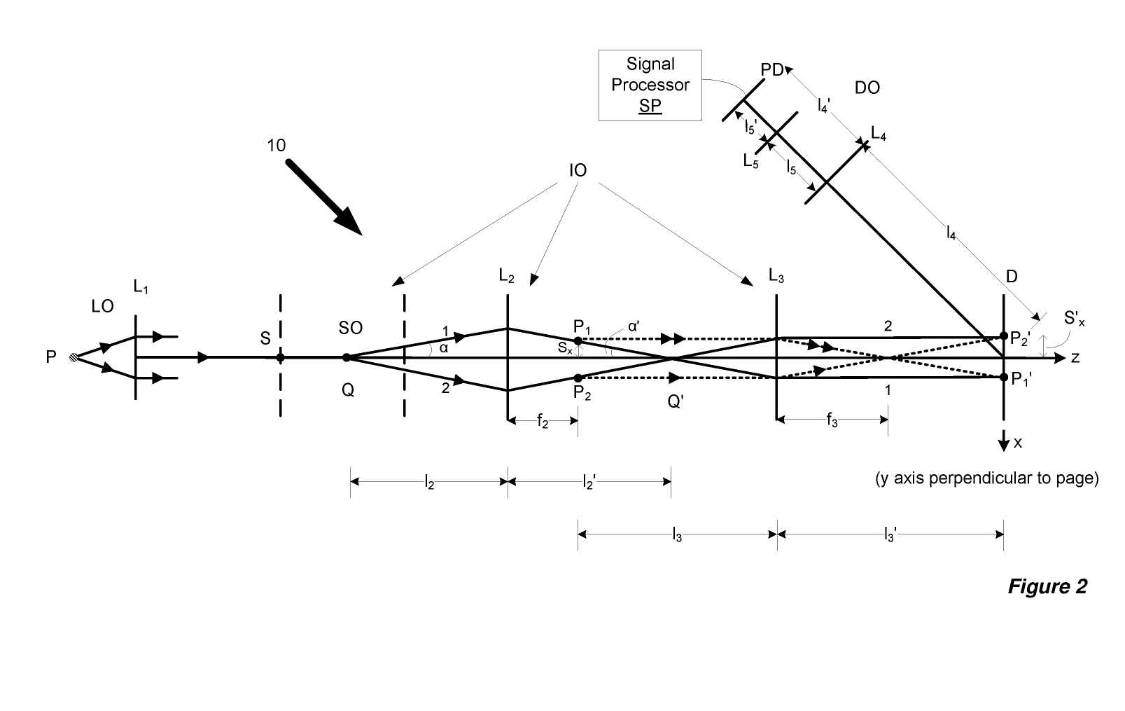

FIG. 2 show one embodiment of the general configuration of FIG. 1 in more detail;

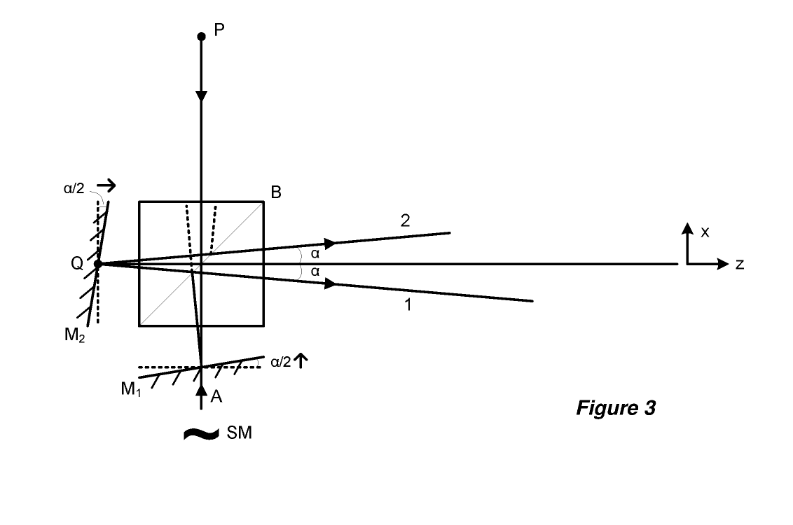

FIG. 3 shows beam shearing optics that are suitable for use in the interferometer apparatus of FIG. 1; and

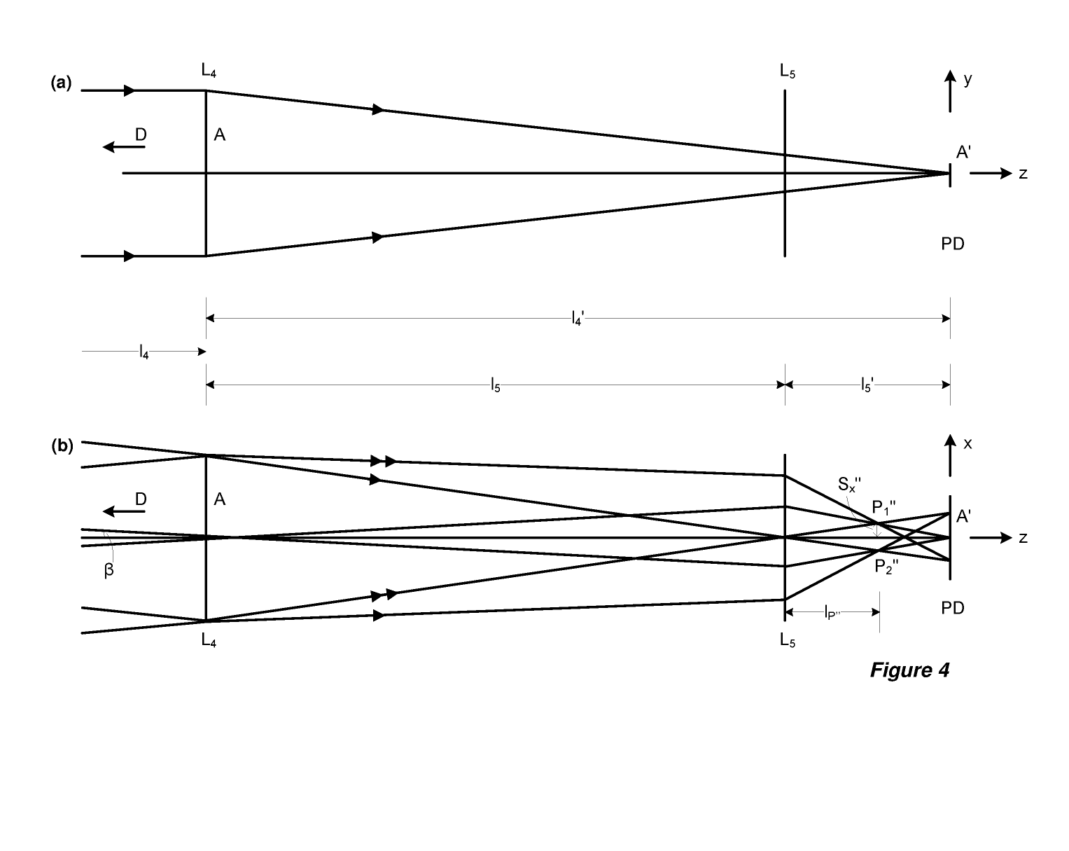

FIGS. 4(a) and 4(b) show, in different respective planes, detection optics that are suitable for use in the interferometer apparatus of FIG. 1;

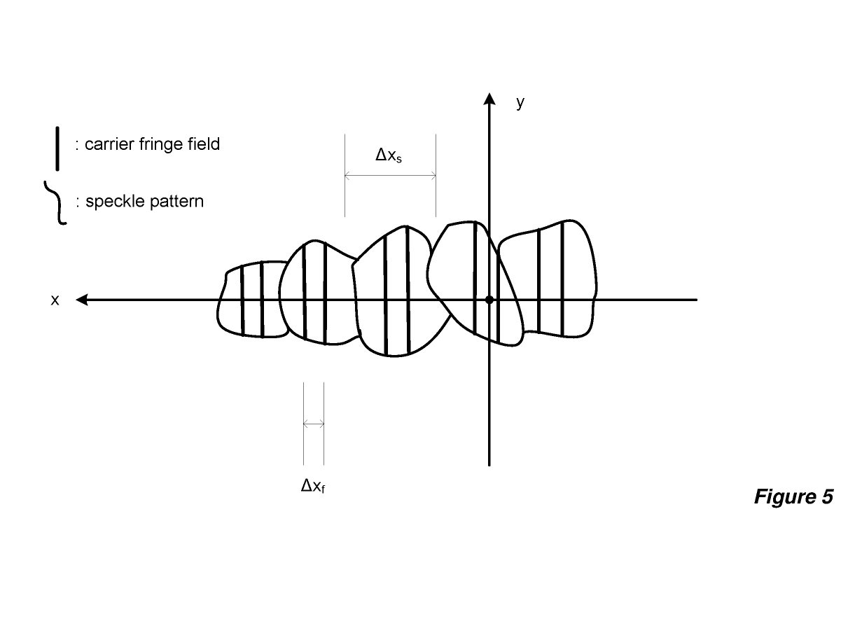

FIG. 5 shows an exemplary representation of how, for optically rough surfaces, carrier fringe field may be superimposed on a speckle pattern using the interferometer apparatus of FIG. 1;

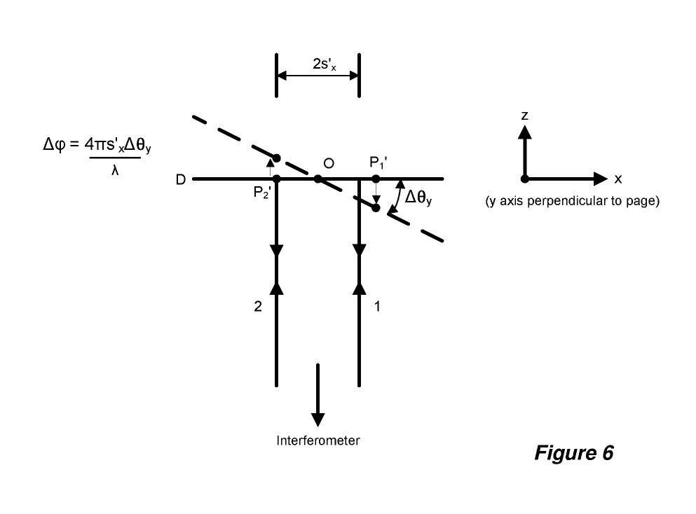

FIG. 6 illustrates the potential use of the interferometer apparatus of FIG. 1 to measure rotational movement of a surface of a measurement object;

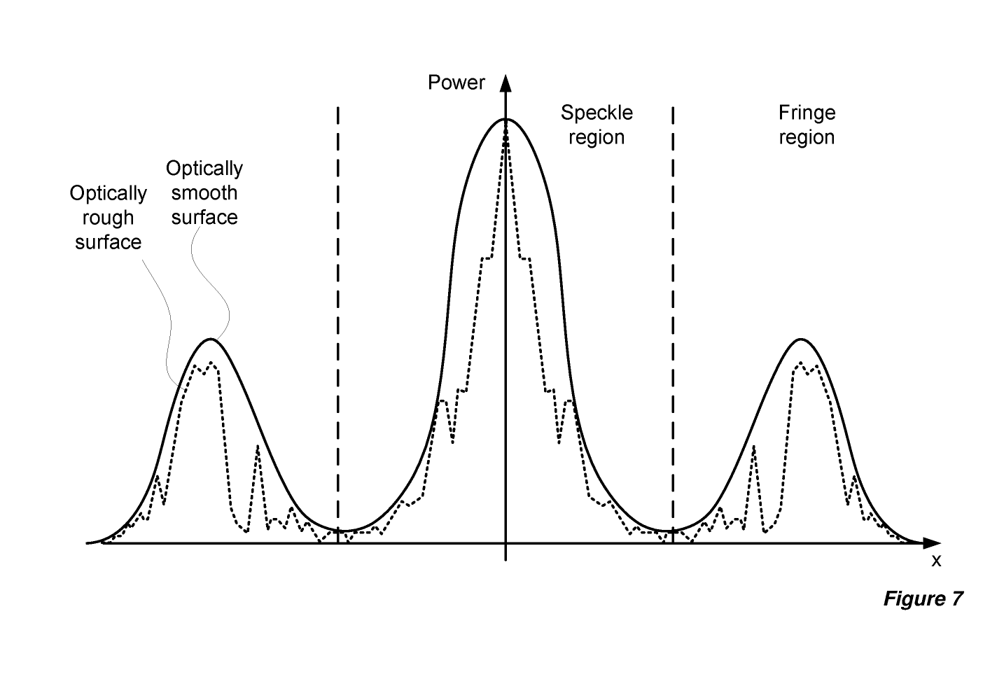

FIG. 7 shows an exemplary spatial power spectrum of a one dimensional sensed image provided by a linear array, in the interferometer apparatus of FIG. 1, for an optically smooth surface and an optically rough surface;

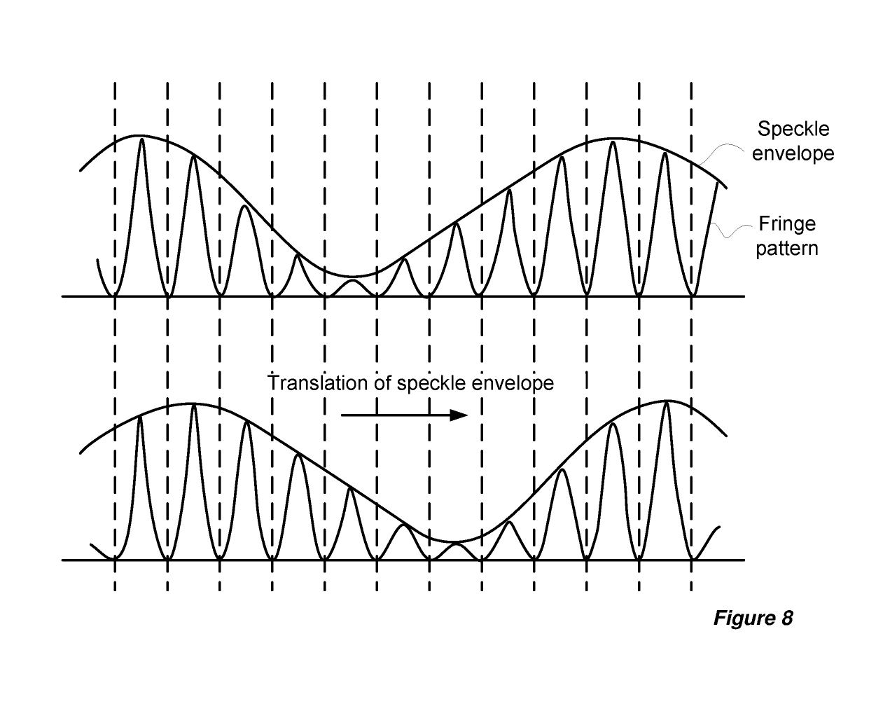

FIG. 8 illustrates the effect of a tangential translation of a measurement object on speckle envelope and fringe patterns for that object;

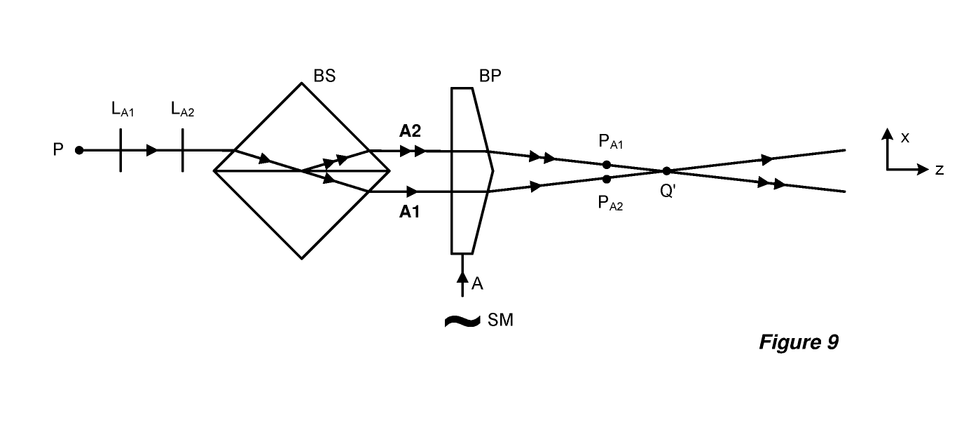

FIG. 9 shows another example of beam shearing optics that are suitable for use in the interferometer apparatus of FIG. 1;

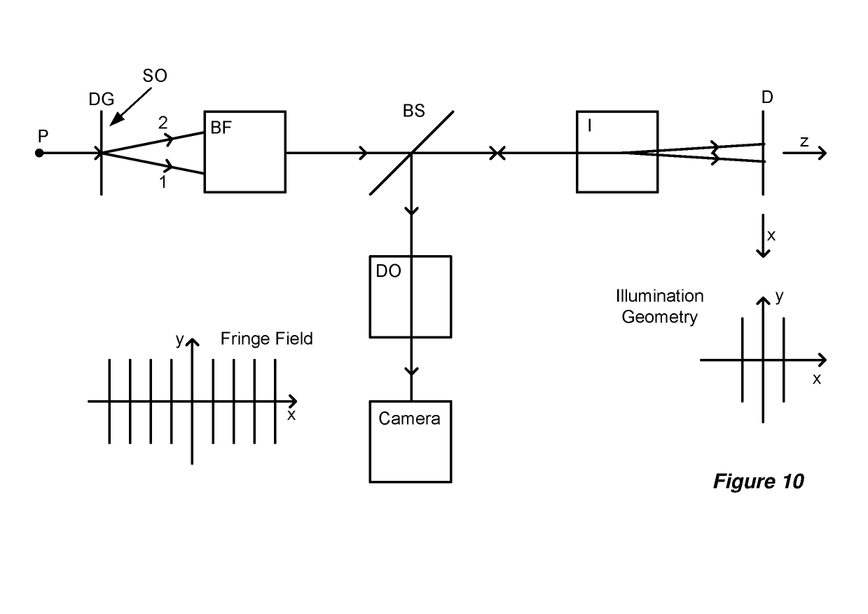

FIG. 10 shows another example of interferometer apparatus in which yet another form of beam shearing optics are used;

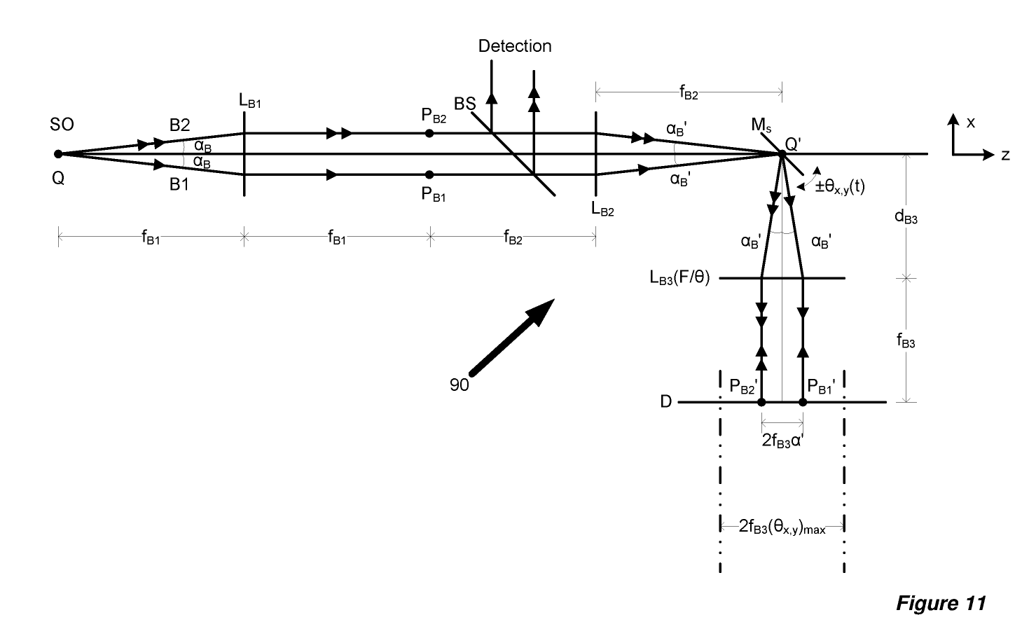

FIG. 11 shows another configuration of exemplary interferometer apparatus that may be used to enable measurements to be performed sequentially over a two dimensional (2D) surface;

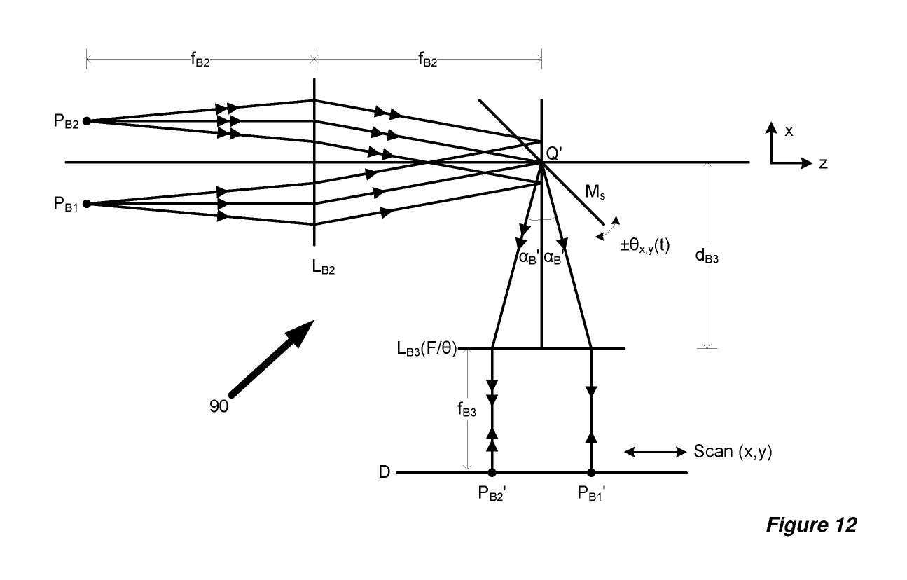

FIG. 12 shows part of the configuration shown in FIG. 9 and illustrates operation of that configuration to scan a measurement surface;

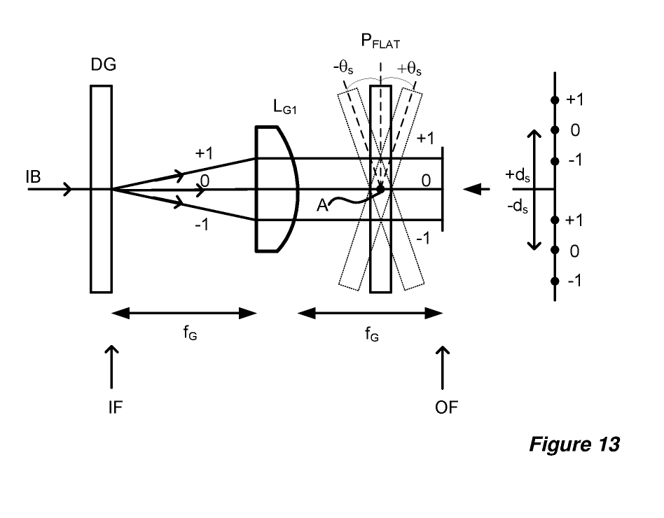

FIG. 13 shows another configuration for scanning a measurement surface;

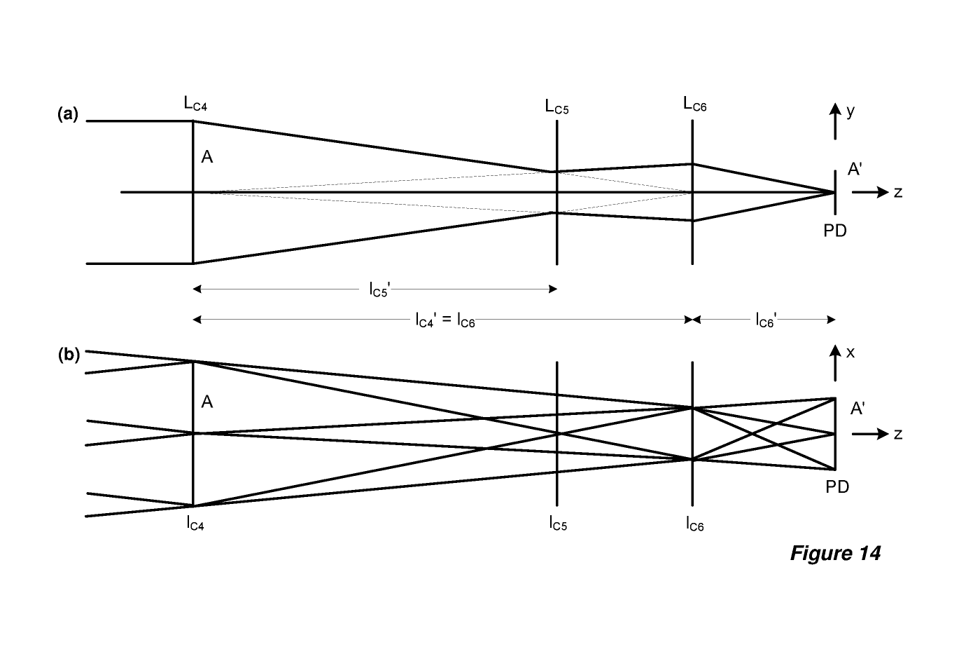

FIGS. 14(a) and 14(b) show, in different respective planes, a further arrangement of detection optics that are suitable for use in the interferometer apparatus of FIG. 1;

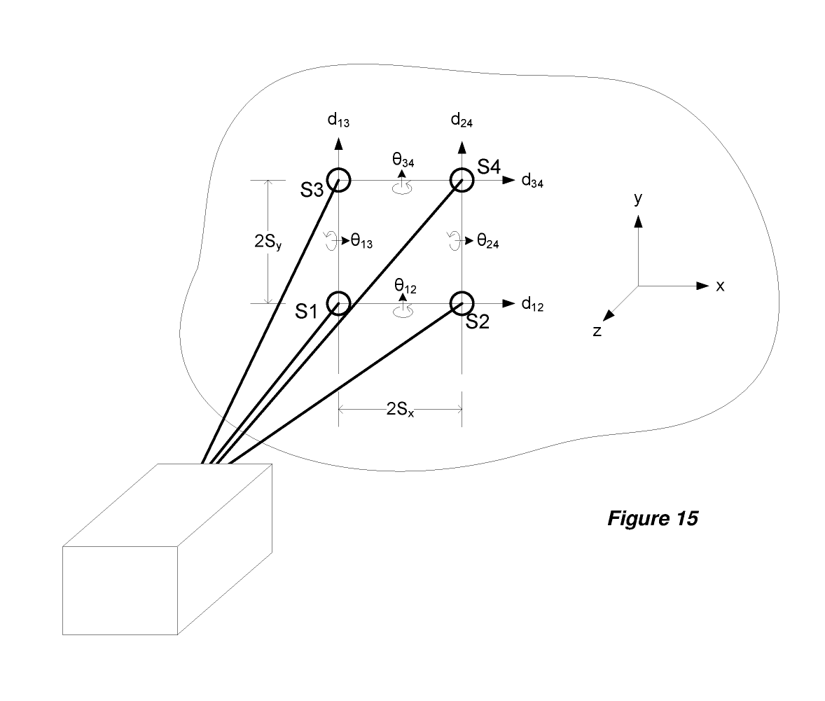

FIG. 15 shows a four-spot interferometer apparatus which can provide measurement of five degrees-of-motion of a measurement object;

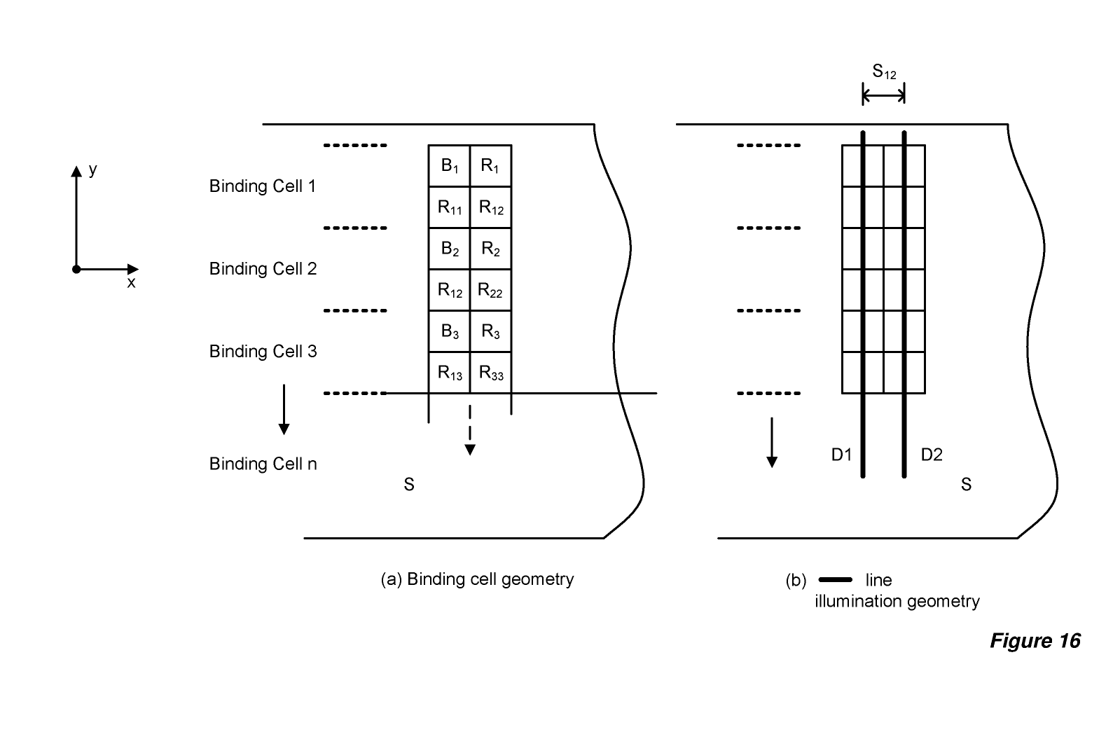

FIGS. 16(a) and 16(b) respectively illustrate, a binding cell geometry and an associated line illumination geometry for use for performing measurements of molecular surface binding;

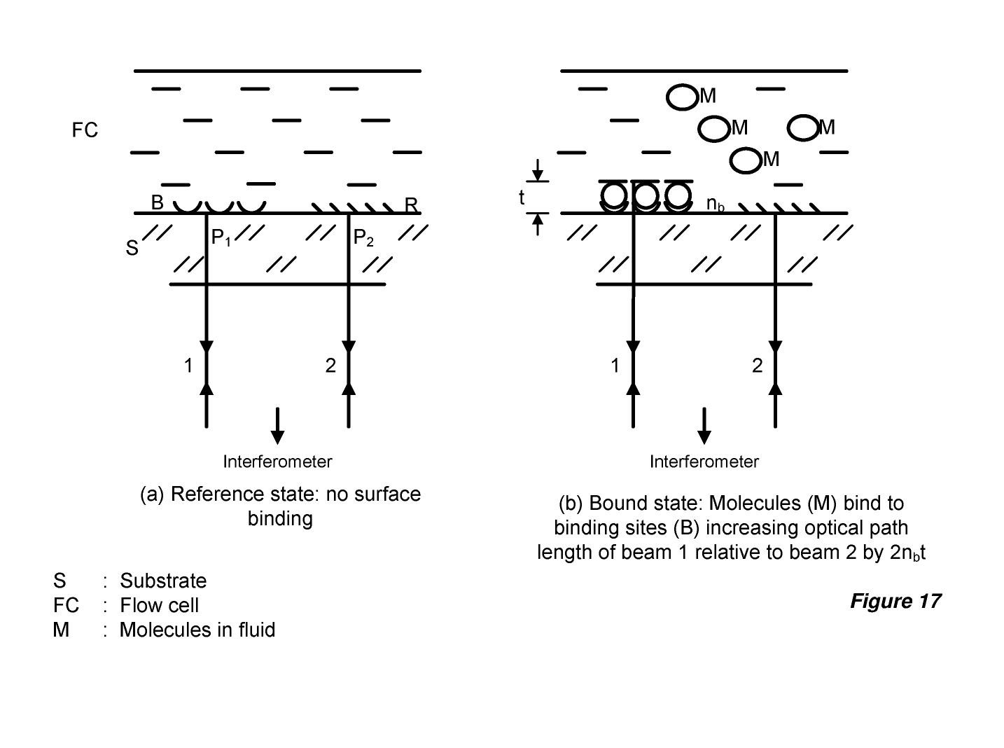

FIGS. 17(a) and 17(b) respectively illustrate illumination, for the purposes of performing label free binding measurements, of: (a) a flow cell in a reference state in which there is no surface binding; and (b) a flow cell in a bound state in which there is surface binding;

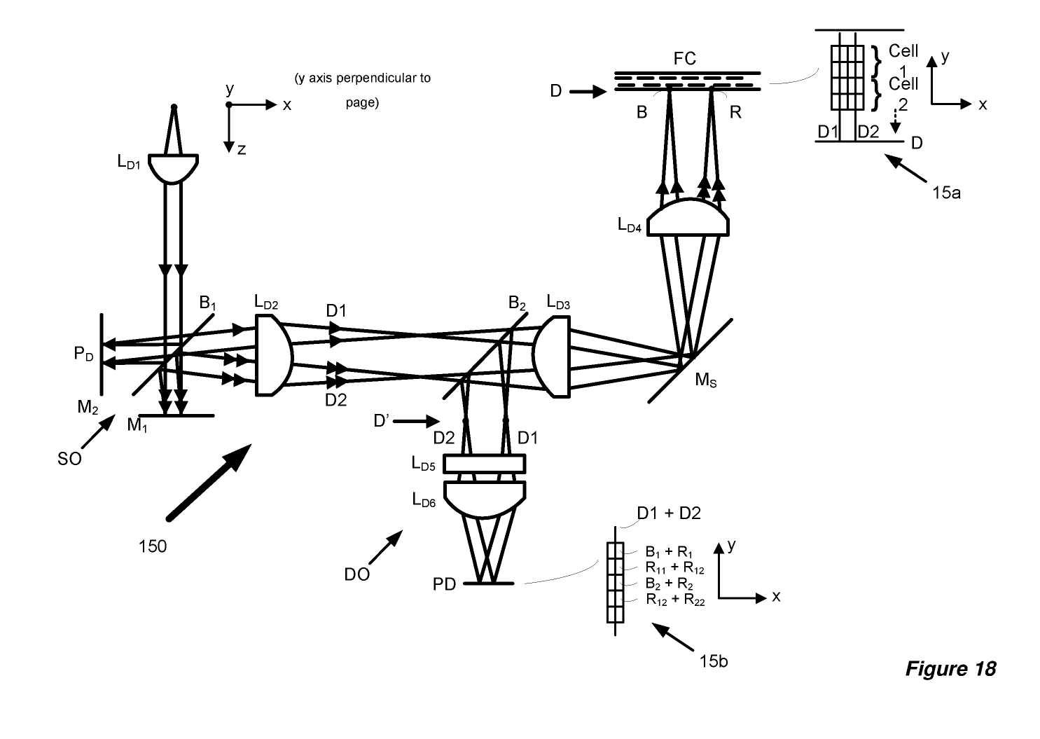

FIG. 18 shows an interferometer apparatus for performing label free binding measurements;

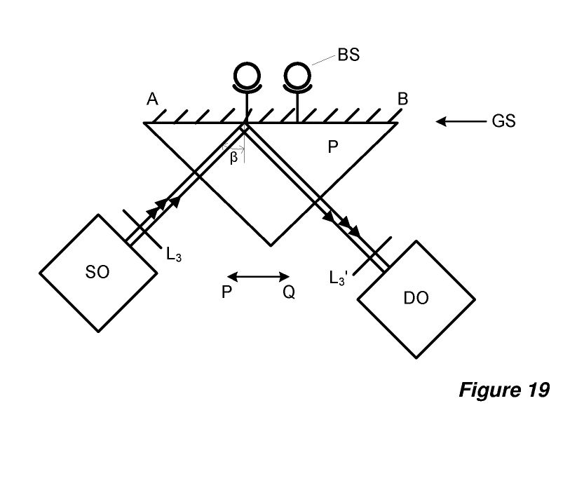

FIG. 19 illustrates one configuration in which a dual spot configuration can be used in conjunction with a surface plasmon resonance (SPR);

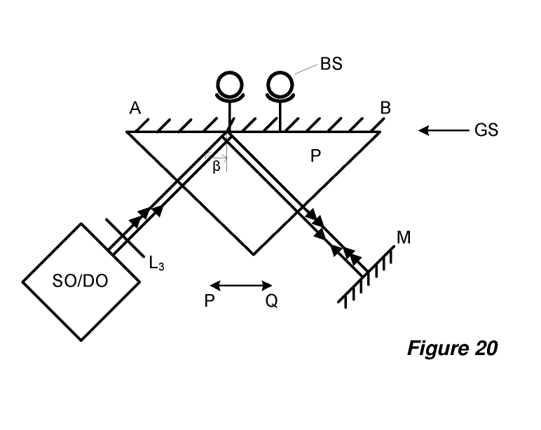

FIG. 20 illustrates another configuration in which a dual spot configuration can be used in conjunction with a surface plasmon resonance (SPR);

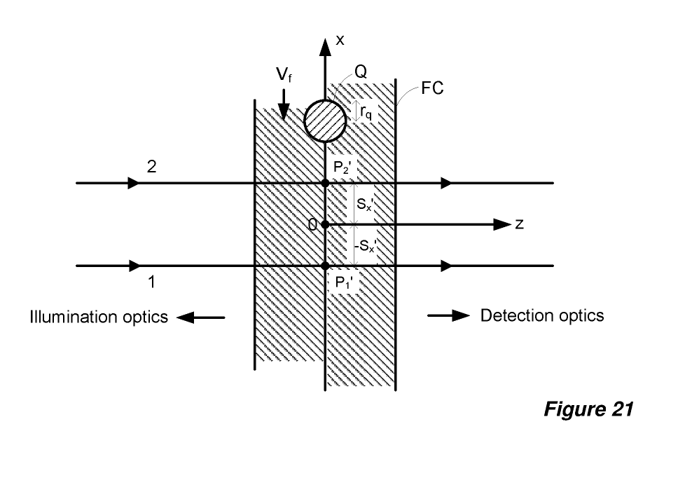

FIG. 21 illustrates how the interferometer apparatus may be adapted for application in interferometric flow cytometry for transmissive measurement;

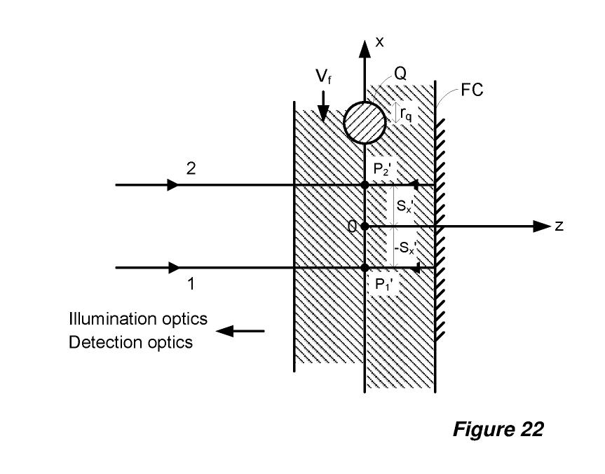

FIG. 22 illustrates how the interferometer apparatus may be adapted for application in interferometric flow cytometry for reflective measurement;

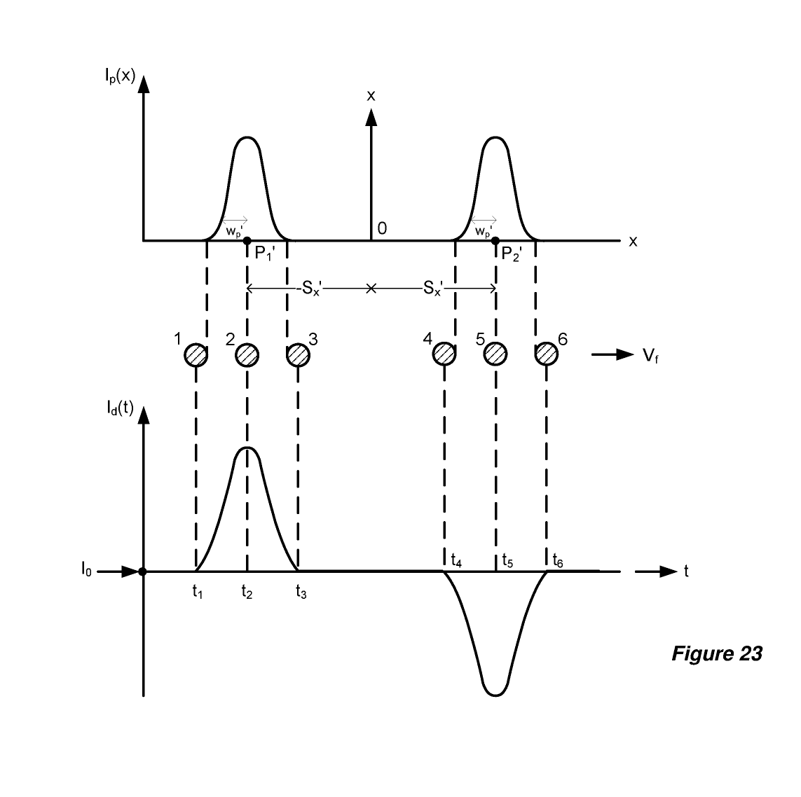

FIG. 23 illustrates, in simplified form, the basic interferometer output that results from passage of a particle during the interferometric flow cytometry illustrated in FIGS. 19 and 20;

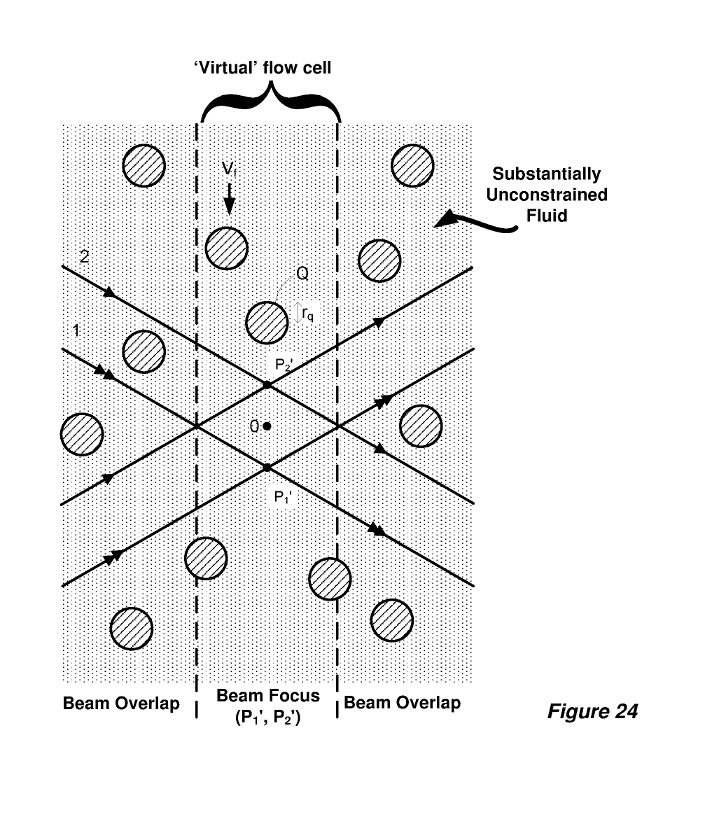

FIG. 24 illustrates, in simplified form, how the interferometer apparatus can be applied in a virtual flow cell application;

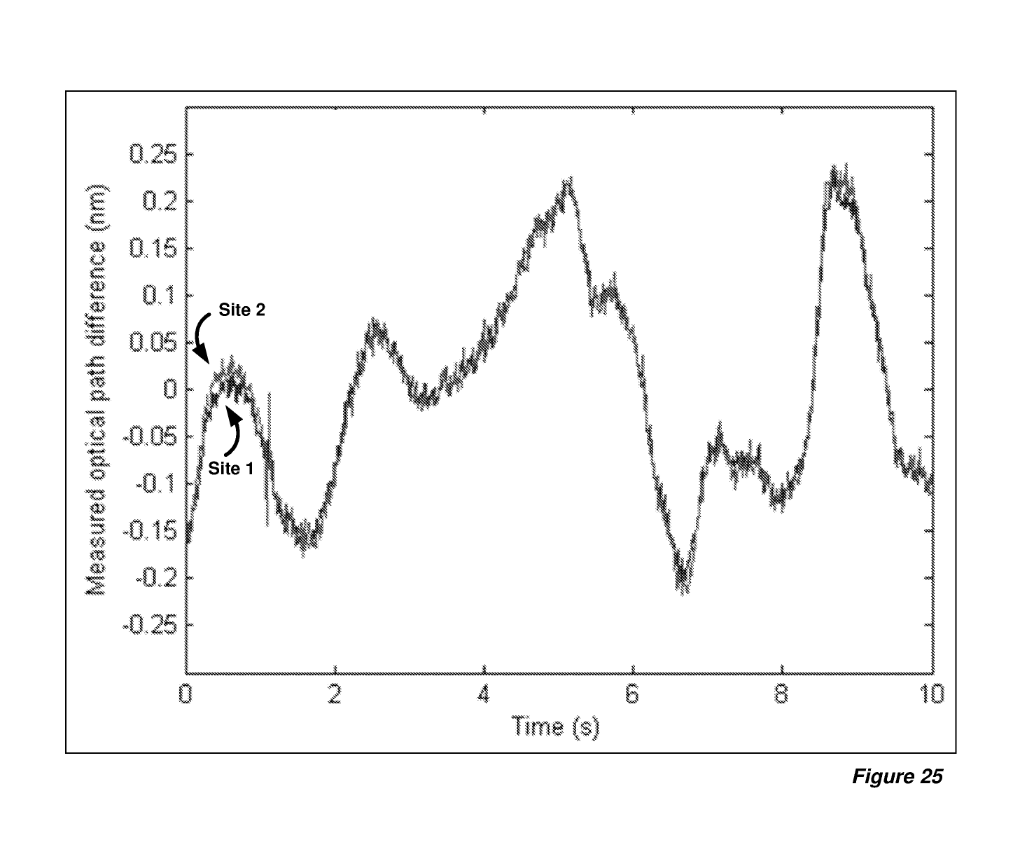

FIG. 25 shows a plot of the changes in measured optical path length over time, for two different illuminated sites; and

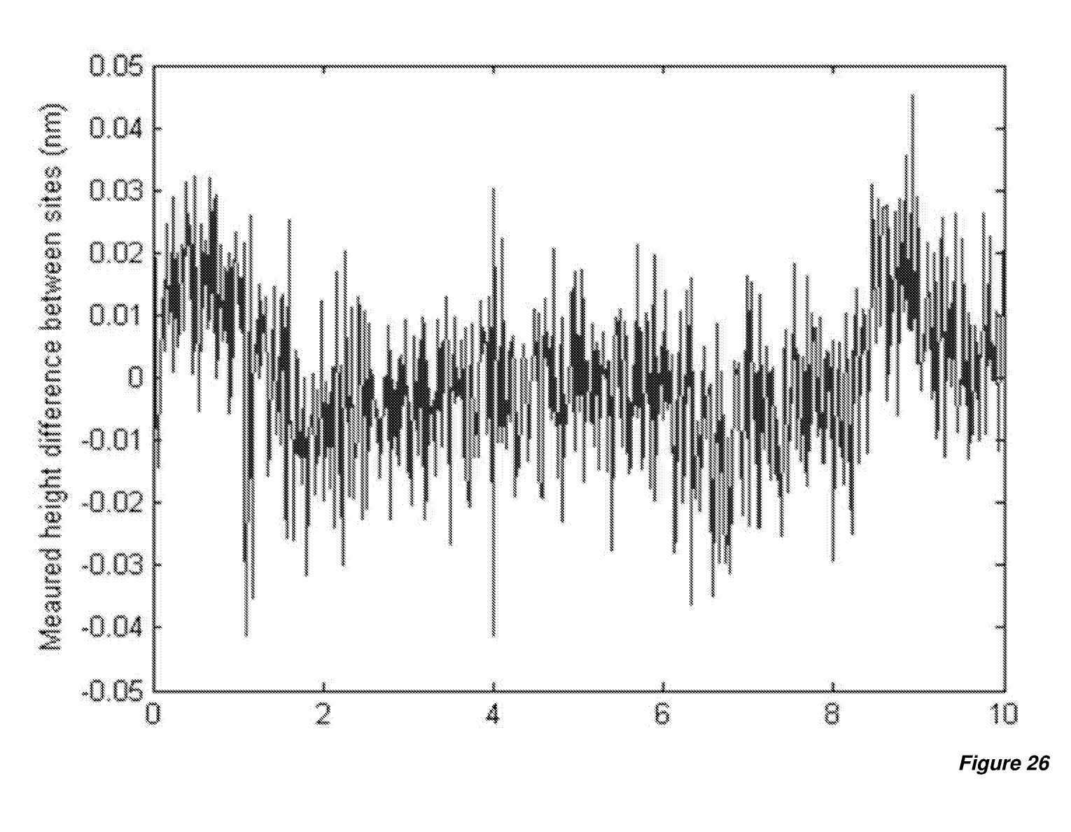

FIG. 26 shows a plot of the differences between the measured optical path lengths for the two sites of FIG. 25.

### OVERVIEW

FIG. 1 schematically illustrates, in overview, a general configuration of exemplary interferometer apparatus, generally at 10, which advantageously makes use of multi-beam common path illumination.

The interferometer apparatus 10 comprises illumination optics IO and detection optics DO. The illumination optics, IO, comprise beam shearing optics, and a lens system (as described in more detail with reference, in particular, to FIG. 2) to bring beams to either a multiple line or point focus in the plane of an object D. The detection optics, DO, comprises beam collection and transformation optics (as described in more detail with reference, in particular, to FIG. 4).

In operation the illumination optics IO transform light from a source S into an array of either lines (a) or points (b) focused in the plane of a measurement surface D and the detection optics DO collect the light reflected/scattered from the surface D and transform it into a linear fringe field FF in the plane of a detector array DA.

The angle of detection (θ₂) to the surface normal (ON) is set equal to the angle of illumination (θ₁) for a specularly reflecting i.e. optically smooth (mirror) surface. The angle of detection θ₂ can be set at any angle of scatter when D is optically rough. (alternatively D may be observed in transmission when it is transparent—not shown in FIG. 1).

In the case of an optically rough surface IO and DO are designed such that the mean size of a resultant speckle pattern in the detection plane is greater than that of the spacing of the fringes within the fringe field FF (as described in more detail with reference, in particular, to FIG. 5).

The position of the fringes within the fringe field FF for a given pair of either adjacent points in the line illumination (a) or discrete illumination points (b) depends on the relative phase of the light reflected/scattered from these points. This makes the fringe field FF sensitive to a number of characteristics of the object, for example, to a rotation of the object (as described in more detail with reference, in particular, to FIG. 6) or a differential change in height at one point (as described in more detail with reference, in particular, to FIG. 17). This relative phase is derived from discrete Fourier transforms of the profile of the fringe field FF recorded at the detector array DA as described in more detail later. The formation of a fringe field in the plane at the detector array DA with a spacing less than that of the mean speckle size is particularly beneficial because it enables signal processing and associated measurements to be extended to optically rough (i.e. non-mirror) surfaces as described in more detail with reference, in particular, to FIGS. 5 and 7. The ability to perform Fourier domain processing in the presence of a speckle pattern generated by optically rough (non-mirrored) surfaces was not previously possible and has the potential to be applied advantageously in many and varied applications.

One particularly beneficial feature of at least some of the embodiments of the interferometer apparatus 10 described herein, compared to known interferometer apparatus, is the use of different configurations of illumination optics IO and detection optics DO. Contrastingly, in known systems the IO and DO generally share the same optical path and hence have identical optical components. This is illustrated, in particular for example, by the configurations shown FIGS. 2 and 4, where the difference in the geometry between the detection optics, DO (comprising lenses L₄ and L₅ in those figures) and the illumination optics IO (comprising beam shearing optics SO and lenses L₂ and L₃ in FIG. 2).

Another particularly beneficial feature of at least some of the embodiments of the interferometer apparatus 10 described herein, compared to known interferometer apparatus, is the use of specific configurations of the shearing optics SO as shown in FIGS. 3, 9, and 10 that are configured primarily for the purposes of creating a pair of beams that diverge with equal angles from a fixed point in space (see, for example, FIG. 2) rather than to generate an output interference pattern.

Referring to FIG. 10, in one particularly beneficial embodiment, the shearing optics SO, somewhat counter-intuitively, do not consist of interferometric components. Instead, a non-interferometric component (a diffraction grating in the example of FIG. 10) is used to provide a sheared beam. This simplifies and reduces the cost the system. Further, the elimination of two beam (e.g. Michelson) interferometric configurations from the illumination optics IO and/or detection optics DO increases the intrinsic stability of the system and has resulted in a significant reduction in displacement equivalent noise floors to a value in the range 1 to 10 picometres.

The use of separate (‘non-common) and different optical configurations in the illumination optics IO and detection optics DO of the interferometer apparatus also enables the generation of the output fringe field FF in a form that is particularly beneficial in terms of its ability to allow accurate Fourier domain phase measurements in which the need for phase modulation (homodyne measurement) or dual frequency sources (heterodyne measurement) are eliminated thereby further allowing significantly less system complexity and hence cost.

In summary, therefore, embodiments of the interferometer apparatus described herein include a number of beneficial features including, but not limited to: the use of separate (‘non-common’) configurations of illumination optics IO and detection optics DO; the use of non-interferometric configurations in the illumination optics IO and detection optics DO; the ability to obtain a Fourier domain phase measurement derived from a carrier fringe field in the plane of detection (e.g. as opposed to known homodyne or heterodyne techniques); and optical design and phase measurement methods that accommodate both rough and optically smooth surfaces.

### Optical Configuration

FIG. 2 schematically illustrates, in more detail, the optical configuration of the exemplary interferometer apparatus 10 of FIG. 1, according to one embodiment. The interferometer apparatus comprises collimation optics LO, illumination optics IO, detection optics DO and a signal processor SP.

The collimation optics LO, act as the source S of FIG. 1, and comprise an illumination source P for producing the electromagnetic waves used by the interferometer apparatus 10, and lens L₁. In this exemplary embodiment, the illumination source P comprises a single mode fibre pig-tailed monochromatic source such as a laser diode or Super Luminescent Emitting Diode (SLED). The light from the illumination source P is collimated by the lens L₁ to form a collimated ray pencil (only the central beam of which is shown for simplicity) before entering the shearing optics SO.

The illumination optics IO comprise shearing optics SO and lenses L₂ and L₃.

The shearing optics SO, in this embodiment, comprise a Michelson configuration (shown in more detail in FIG. 3). The shearing optics SO divide the beam into two component beams 1, 2 which diverge at an angle ±α to the optical axis (small enough for the small angle or ‘paraxial’ approximation to apply) from a common point Q until the diverging light reaches second lens L₂, located at a distance l₂ from the common point Q.

The lens L₂ causes the two component beams 1, 2 to converge, at an angle ±α′ to the optical axis (small enough for the small angle or ‘paraxial’ approximation to apply), to conjugate point Q′ at a conjugate distance l₂′ from lens L₂. Lens L₂ forms, at conjugate point Q′, an image of the light at the common point Q, with magnification m₁=l₂′/l₂. Translated images of the source P are thereby formed at points P₁ and P₂ in the focal plane of L₂ at the focal length f₂ of lens L₂, and are symmetrically centred at a separation sₓ about the central optical axis where sₓ=±f₂α (using the small angle approximation).

Lens L₃, having focal length f₃, is located at a distance l₃ from the focal plane of lens L₂ and receives light from it as illustrated in FIG. 2. Lens L₃ is arranged at a distance l₃′ (where l₃′=(f₃⁻¹−l₃⁻¹)⁻¹) from an object plane D (e.g. a plane of a surface of a measurement object) such that the object plane D is at the plane conjugate to the plane containing P₁ and P₂, with reference to lens L₃. An image of the translated images at P₁ and P₂ is thus formed at points P₁′ and P₂′ in the object plane D, by the lens L₃, with magnification m₂=l₃′/l₃ and centred with separation ±sₓ′=m₂sₓ from the optical axis. Two discrete regions of the object are thereby illuminated with mutually coherent light fields or ‘spots’ centred at points P₁′ and P₂′. The light fields projected onto the measurement object produce an associated speckle pattern (where the surface on which the light is projected is optically rough) for observation via the detection optics DO. Moreover, interference between the light fields projected onto the measurement object produce a fringe field at the detection optics DO.

The radius wₚ, of each illumination field produced by lens L₃, centred respectively at P₂′ and P₁′, is a combined function of the optical parameters for the layout shown in FIG. 2 and the form of the illumination source P. In this embodiment, the illumination source P is assumed to generate, via L₁, a collimated beam profile having a 1/e² radius w₁. The radius wₚ, of each illumination field centred respectively at P₂′ and P₁′ is then given, using standard Gaussian beam propagation, by:

$${w}_{{p}^{′}} = \frac{0.32 {m}_{2} λ {f}_{2}}{π {w}_{i}} \qquad ( 1 )$$

where λ is the wavelength of the light.

The distance between P₂′, P₁′ is 2sₓ′ where,

$${s}_{x}^{′} = \frac{{l}_{3}^{′} {f}_{2} α}{{l}_{3}} \qquad ( 2 )$$

The detection optics DO (shown in more detail in FIG. 4), in this embodiment, comprises a photo detector PD and lenses L₄ and L₅. In order to make a measurement the objective speckle pattern, from the illumination regions at P₁′ and P₂′, at an entrance pupil of the detection optics DO is imaged onto the plane of the photo detector PD by means of lenses L₄ and L₅.

The signal processor SP receives data representing the light incident on the photo detector PD and processes it to derive information identifying characteristics of the surface of the measurement object onto which the light is projected in the object plane D.

Beneficially, therefore, it can be seen that the interferometer apparatus 10 uses beam shearing optics SO to project two mutually coherent areas of light onto an object at P₁′ and P₂′, via a common path, thereby making the interferometer intrinsically robust.

Further, the interference between the projected areas forms a carrier fringe field, at the detection optics DO, with the phase of the fringe field being determined by the difference in the optical path length of the two sheared beams to the object. Beneficially, therefore, by measuring changes in the phase of this fringe field it is possible to determine changes in the relative path length as caused by changing surface parameters caused, for example, by movement of the surface as a result of flexing or vibration.

This carrier fringe field may beneficially be observed in the presence of speckle pattern thereby enabling the interferometer to be used for the measurement of objects with either optically rough or smooth surfaces.

In addition, because, the path lengths of the interfering beams are matched short coherence sources such as SLEDs may be used. These have non-resonant emission and are not subject to modal phase noise characteristic of standard multi-mode lasers sources. The short coherence also has the knock on benefit of effectively eliminating multiple path interference that can result from the use of a single mode laser which has an intrinsically long coherence length

The above features, combined with the use of either carrier fringe phase quadrature or tracking algorithms, also provide the basis for designs, described in more detail later, for which optimal performance may be achieved for a wider range of applications and operating environments than conventional interferometry allows.

### Shearing Optics

The beam shearing optics SO will now be described in more detail, by way of example only, with reference to FIG. 3 which shows beam shearing optics, based on a Michelson interferometer, that are suitable for use in the interferometer apparatus 10 of FIG. 2.

In the arrangement shown in FIG. 3, a pair of Michelson mirrors M₁ and M₂ and a beam splitter BS are arranged with the mirrors M₁, M₂ inclined at ±α/2 to form the two beams diverging from Q via the beam splitter BS at ±α/2 to the z axis (as shown in FIG. 3).

Sinusoidal modulation SM of the phase in one arm of the Michelson interferometer may be introduced by applying a small sinusoidal displacement normal to the surface of a mirror (in this example M₁) in the Michelson interferometer using an actuator A (such as a piezo stack or the like) attached to the mirror M₁.

### Detection Optics

The detection optics DO will now be described in more detail, by way of example only, with reference to FIGS. 4(a) and 4(b) which show, in xy and xz planes respectively, detection optics DO that are suitable for use in the interferometer apparatus 10 of FIG. 2.

In the detection optics DO of this embodiment, the photo detector PD is a linear photo detector comprising a linear array of individual detectors such as photodiodes, lens L₄ comprises a spherical lens arranged, at the entrance pupil of the detection optics DO, to form aperture A at which the light field diffracted from the measurement object is received. Lens L₅ comprises a positive cylindrical lens. As seen in FIG. 4(a), the lens L₅ is arranged such that, in the yz plane, it does not affect the passage of light through it.

The linear photo detector PD is arranged parallel to a line containing points P₁′ and P₂′ (e.g. along the x axis) and the plane containing points P₁′ and P₂′ is imaged onto the linear photo detector PD, along the x axis, by the spherical lens L₄ (as seen in FIG. 4(a)).

As seen in FIG. 4(b), the lens L₅ is arranged such that the objective speckle pattern is imaged onto the photo detector PD, in the long axis of the linear photo detector, by the positive cylindrical lens L₅. In this axis lens L₄ serves to gather light onto lens L₅, thereby lowering the numerical aperture (NA) required for lens L₅.

The resulting image A′ is an image of aperture A along the x axis, and of the object plane D in the y axis. This arrangement maps all of the light passing from points P₁ and P₂ through A onto the linear PD, and maintains the elevated content at the spatial frequencies corresponding to the fringe spacing Δx_{F} (see equation (5) below).

In the detection optics DO, both axes are focussed by ensuring:

l₄′=l₅+l₅′ (3)

Where l₄′ is the distance from lens L₄ to the plane conjugate to D for lens L₄, and l₅ and l₅′ are the respective distances from lens L₅ to each of its imaging conjugates in the xz plane as illustrated in FIG. 4(b).

Under these conditions an image is formed at points P₁″ and P₂″, of the object plane focal spots at points P₁′ and P₂′, is formed at a distance lₚ″ from L₅, centred with a separation ±sₓ″ about the central optical axis, with:

$${s}_{x}^{″} = \frac{{s}_{x}^{′} ( {l}_{5}^{′} - {l}_{{P}^{″}} )}{{m}_{3} {l}_{4}} \qquad ( 4 )$$

where the magnification provided by lens L₅, m₃=l₅′/l₅.

The two beams diverging from P₁″ and P₂″ interfere in the photo detection plane to generate fringes of spacing Δx_{F}, with:

$$Δ {x}_{F} = \frac{{m}_{3} {l}_{4} λ}{2 {s}_{x}^{′}} \qquad ( 5 )$$

where λ is the wavelength of light.

When D is optically rough L₅ will also image the objective speckle pattern present in the plane of the aperture A. This speckle pattern will, however, be modulated by the fringes described above. This speckle pattern will have an average dimension Δxₛ given by:

$$Δ {x}_{S} = \frac{m {l}_{41} λ}{2 {w}_{{p}^{′}}} \qquad ( 6 )$$

where wₚ, is the radius of illumination at P₁′ and P₂′ (see equation (1)).

Unlike conventional speckle pattern interferometry, imaging is of the objective speckle pattern rather than the subjective speckle pattern. Unlike conventional speckle pattern interferometry, therefore, the average speckle size for a given wavelength is defined by the dimensions of the illumination field rather than by the characteristics (such as the f-number) of the viewing optics, as would be the case for subjective speckle.

FIG. 5 shows an exemplary representation of how, for optically rough surfaces, carrier fringe field may be superimposed on a speckle pattern in a situation where the average speckle size Δxₛ is larger than the fringe spacing Δx_{F}. The ratio n_{sf} of the average speckle size Δxₛ to fringe spacing Δx_{F} in the detection plane is given by:

$${n}_{sf} = \frac{{s}_{x}^{′}}{{w}_{{p}^{′}}} \qquad ( 7 )$$

The optical system may thus be designed such that n_{sf}>1 thereby enabling the fringe pattern to be observed within the individual speckles as shown in FIG. 6. The observation of the carrier fringes in this way beneficially enables the interferometric measurement to be extended to optically rough surfaces.

It will be appreciated that whilst the above example has been described with reference to a 1D (linear) photo detector, the design may be extended to a 2D detector array by replacing the L₅ cylindrical lens by an equivalent spherical lens, albeit that this would change the required processing scheme, and would generally reduce the achieved signal to noise ratio.

Moreover, whilst having the detection optics DO and the optics for illuminating the measurement surface separately is advantageous as it allows analysis to be carried out remotely from the illumination apparatus, it will be appreciated that in some applications it may be advantageous to have the detection optics DO integrated within the main illumination apparatus (e.g. as shown in FIG. 18).

### Operation to Measure Movement of Measurement Object

FIG. 6 illustrates, in simplified form, the principle of operation of the interferometer to measure rotational movement of a surface of a measurement object.

As seen in FIG. 6, a rotation of the surface of a measurement object, at the object plane D, through an angle Δθ_{y} around the y axis (perpendicular to the plane of FIG. 6) through the mid-point O between P₁′ and P₂′ introduces a relative phase difference of Δφ_{y}=4πs′ₓΔθ_{y}/λ, between the two beams. This translates the speckle pattern at the aperture plane A by a distance 2Δθ_{y}l₄.

The phase change due to rigid body displacements (dₓ, d_{y}, d_{z}), and in plane rotations and tilt about the x axis are common to both beams and so do not create a relative phase change. Similarly, higher order surface motion (e.g. a flexure of the surface which leaves the midpoints of P₁′, P₂′ unchanged) alters the speckle structure, but do not translate the underlying fringe field.

The common object illumination therefore enables either small angular tilts about a point in the surface or the relative refractive index at the proximity of P₁′, P₂′ to be measured in the presence of macroscopic rigid body displacements, macroscopic movement of the sensor, and refractive index variations common to the beam paths and enhances the intrinsic robustness of the interferometer.

In the case of optically rough surfaces, however, such macroscopic displacements will result in the speckle pattern decorellation of the carrier fringe field and the maintenance of continuous phase measurement under these conditions is a particularly beneficial aspect of the signal processing used to extract information about the measurement object, as described in more detail below.

### Signal Processing to Determine Changes in Rotational Position

Operation of the signal processor SP to determine a change in rotational position will now be described in more detail, by way of example only, for the photo detector PD comprising a linear array as described in the above embodiment, and for a photo detector PD comprising a point detector (e.g. an individual photo diode or the like).

### Linear Array

For linear array detection, a linear array having a pixel height greater than wₚ, l₄′/l₄ is used at the photo detector to ensure that the light from the measurement object is all collected at the sensor. The pixel pitch of the linear array is approximately Δx_{F}/4 (or possibly lower) thereby allowing a sufficient fringe resolution.

FIG. 7 shows an exemplary spatial power spectrum of a one dimensional (1D) sensed image provided by a linear array for an optically smooth or ‘specular’ surface (shown as a solid line) and an optically rough surface (shown as a dashed line). In FIG. 7, the discrete spatial power spectrum of the sensed 1D image produced at the linear array is the autocorrelation of the complex amplitude function at the illuminated surface of the measurement object.

The elevated content around the spatial frequency ω_{F} corresponds to the fringe spacing Δx_{F} in reciprocal space; this region arises from one of the spots of light incident on the measurement object interfering with the other, and is referred to herein as the fringe content or fringe region. The area around the origin results from the self-interference of each spot, which is referred to herein as the speckle content or speckle region. Configuring the optics of the interferometer apparatus such that the separation sₓ′ between each region of illumination on the surface of the measurement object and the central optical axis is much greater than the radius of the illumination wₚ, (sₓ′>>wₚ,) ensures that the fringe and speckle regions are well separated.

The processing algorithm compares the complex spatial spectra (obtained via a discrete Fourier transform (DFT)) of two consecutive 1D images or ‘frames’. A pure rotation of the object Δθ_{y} results in a linear phase difference between the two frames in reciprocal space, with a gradient proportional to Δθ_{y}. Whilst confounding factors can result in a deviation from this linearity for the speckle content, the cancellation of these factors between spots means that it provides a sufficiently accurate model for the fringe content.

The phase gradient in the fringe content can be determined using linear regression; weighted by the power in each spatial frequency (the weighting being selected to additionally remove the speckle content). From this the rotation of the object Δθ_{y} between the two frames can be determined.

The above method is applicable when the rotation of the object Δθ_{y} is less than half the fringe spacing divided by the distance from the measurement object to lens l₄ (Δθ_{y}<Δx_{F}/2l₄) (i.e. the x translation of the fringe field is under half a fringe). If this is not the case then the integer number of fringes translated between frames is determined first, for which the signal inclusive of the larger scale speckle structure can be tracked in the same manner as is described above for the fringe content only. However, as any approach for doing this could be susceptible to errors at integer multiples of Δx_{F} this can be done most successfully where the bulk motion is at a frequency far lower than the frame rate. The integer number of fringes shifted per frame can then be averaged over many frames, and the sub-fringe shift then calculated using the methods described.

Where this averaging technique is used, it is important that the individually calculated frame-to-frame shifts have zero mean error. For this reason standard phase correlation techniques may not be suitable. One approach found to be particularly successful is to find the integer pixel translation which minimises the sum of the squares of the pixel errors.

### Point Detector

In the case of a point detector, the point detector measures the total intensity is some region of the fringe field at photo detector PD. Rotations of the measurement object result in an output ψ, which is sinusoidal (plus some constant) as the fringe field sweeps past the detector. Determining changes in phase Δφ of this sinusoid is therefore effectively equivalent to measuring the rotation Δθ_{y}. The sinusoidal content of this signal is maximised when the width of the point detector is equal to half the fringe spacing (i.e. Δx_{F}/2).

Phase generated carrier demodulation is then use to extract the rotation Δθ_{y} from this oscillatory output. This is achieved by introducing a known additional phase modulation Δφ≈π sin(ωt) into one of the arms of the Michelson interferometer shown in FIG. 3 to introduce a known sinusoidal variation to the angle at which the sheared component beams 1, 2 diverge from the interferometer at Q. The piezo actuator A attached to one of the Michelson shearing optics mirror, for example M₁ as shown in FIG. 3, may be used for this purpose. The signal at the detector then takes the form

ψ=sin(π sin(ωt)+φ₀) (8)

where φ₀ is the phase of the fringe field when Δφ=0.

The amplitude of the fundamental and second harmonic of ψ are in quadrature as a function of φ₀. This means that the phase φ can be determined unambiguously, and bulk motions covering multiple fringes can be tracked.

The quadrature relationship holds provided that φ₀ is approximately constant over the course of a single modulation cycle. For this reason signals can only be detected using this processing scheme at a frequency lower than ω/2 and with the rotation Δθ_{y} being much less than the separation sₓ′ of the each region of illumination from the central optical axis multiplied by the frequency of the additional phase modulation component divided by the wavelength of the light (Δθ<<ωsₓ′/λ).

### Signal Processing to Determine Tangential Translations

Operation of the signal processor SP to determine tangential translations (specifically in-plane movement of the illuminated surface of the measurement object in the x direction) will now be described, by way of example only, with reference to FIG. 8 which illustrates the effect of a tangential translation of a measurement object on the speckle envelope and fringe patterns for that object.

In the example of FIG. 8, the movement represented is a ‘pure’ translation (with no rotation of the measurement object) along a straight line containing the spots P₁′, P₂′. Hence, the phase of the fringes in the fringe pattern remains unchanged whilst the speckle envelope moves as illustrated in FIG. 8.

Determination of the extent of the tangential translation can be achieved by defocussing the projection optics (FIG. 2) such that the beam waists for spots P₂′, P₁′ are formed an axial distance z_{R} from the object, where z_{R} is the Raleigh range for P₂′, P₁′ thereby maximising the wavefront curvature R of the two beams at the object.

Assuming that the object is an optically rough surface with profile f(x) then the complex amplitude E(x) for a single spot upon reflection from the surface of the measurement object is given by:

$$E ( x ) ∝ exp [ - \frac{2 {x}^{2}}{{w}_{{P}^{′}}^{2}} - ik ( \frac{{x}^{2}}{2 R} + 2 f ( x ) ) ] \qquad ( 9 )$$

where k is the wavenumber of the light and i is the square root of −1.

If the measurement object is translated a distance ox parallel to the line containing spots P₂′, P₁′ then the new amplitude, E′ (x), is:

$${E}^{′} ( x ) ∝ exp [ - \frac{2 {x}^{2}}{{w}_{{P}^{′}}^{2}} - ik ( \frac{{x}^{2}}{2 R} + 2 f ( x - δ x ) ) ] ∝ exp [ - \frac{2 {( x - δ x )}^{2}}{{w}_{{P}^{′}}^{2}} + \frac{4 x δ x}{{w}_{{P}^{′}}^{2}} + O ( δ {x}^{2} ) - ik ( \frac{{( x - δ x )}^{2}}{2 R} + \frac{( x - δ x ) δ x}{R} + 2 f ( x - δ x ) + const ) ] \approx E ( x - δ x ) \times exp ( \frac{4 x δ x}{{w}_{{P}^{′}}^{2}} ) \times exp ( - ik \frac{x δ x}{R} ) \qquad ( 10 )$$

The first term represents a pure translation of the field at the object, resulting in a linear phase shift of the light along the sensor, which is not detectable. The second term is suppressed by the first, except for where x˜wₚ′, so is of order exp

$$( \frac{δ x}{{w}_{{P}^{′}}} ) \approx 1 ,$$

assuming

$$\frac{δ x}{{w}_{{P}^{′}}} << 1.$$

It can be seen, therefore, that the result of the translation is results from the third term, an apparent linear phase shift across the spot, proportional to the size of the translation δx.

This also applies for the other spot so that each spot receives an identical linear phase shift. These two shifts cancel out in the fringe region (see FIG. 8) but appear as a translation of the speckle component at the sensor.

This phase shift can thus be measured, using the techniques described above for measuring the phase shift of the fringe field using the linear array, and hence the magnitude of the translation of the measurement object in the x direction can be determined. In the event that the measurement object is exhibiting rotation as described earlier in addition to the tangential translation, the phase shift contribution made by such rotation can determined from the changes to the fringe field (as described earlier) and subtracted from the measured phase shift effectively to eliminate the effect of the rotation on the measurement of tangential translation.

It will be appreciated that, via the inclusion of a second orthogonal spot-pair, using this technique allows translations tangential to the surface to be measured along either of two axes within the plane of the measurement surface. Further, rotation of the measurement surface about an axis normal to the plane of the measurement surface can be determined by measuring the relative differential translations at two separate locations

### Modifications and Alternatives

A detailed embodiment has been described above. As those skilled in the art will appreciate, a number of modifications can be made to the above embodiment whilst still benefiting from the inventions embodied therein. By way of illustration only a number of these alternatives and modifications will now be described.

### Simplified Beam Shearing Optics

FIG. 9 shows another example of shearing optics SO that may be used to generate two component beams for the interferometer apparatus of FIG. 2 (or other configurations of interferometer apparatus described herein or otherwise). The beam shearing optics SO of FIG. 9 simplifies the shearing optics SO compared to those based on the Michelson interferometer of FIG. 3.

As shown in FIG. 9, the shearing optics SO comprise a beam splitter BS and a bi-prism BP.

The beam splitter BS is arranged, at an angle relative to the main optical axis, to generate the two parallel component beams A1, A2 from a collimated beam produced at lens L_{A1} via lens L_{A2}.

The bi-prism BP is arranged to receive the parallel component beams A1, A2 and to converge the two component beams A1, A2 to a common point of intersection (corresponding to Q′ in FIG. 2). Lens L_{A1} and lens L_{A2} are adjusted to create the focal points at P_{A1} and P_{A2} as required.

In this example, sinusoidal plane modulation SM may be created by applying a lateral sinusoidal displacement SM to the bi-prism BP via the actuator A as shown in FIG. 9.

It will be appreciated the above simplified system may also be configured to create a pair of collimated beams that diverge from a point corresponding to Q in FIG. 2 (or FIG. 11 e.g. in a similar manner to the shearing optics SO based on the Michelson interferometer of FIG. 3) with lens L_{A2} following Q and being arranged to modify the component beams A1, A2 as described with reference to FIG. 2 (or later with reference to FIG. 11).

FIG. 10 shows an interferometer apparatus, similar to those described previously, but in which yet another form of shearing optics SO is used to generate two component beams. The other components of the interferometer apparatus of FIG. 10 are similar to those of other embodiments described elsewhere and will not be described in detail.

The beam shearing optics SO of FIG. 10 simplify the shearing optics SO compared to those based on the Michelson interferometer of FIG. 3 and the beam splitter of FIG. 9 even further.

As shown in FIG. 10, the shearing optics SO comprise a non-interferometric component which, in this example, is comprises a holographic element in the form of a diffraction grating DG such as a sinusoidal Holographic grating or the like (although it may comprise any other form of grating or appropriate non-interferometric component e.g. an analogue or computer generated holographic element).

The diffraction grating DG is configured to generate the two (and possibly more) diverging component beams 1, 2, from a collimated beam, similar to the component beams generated by the shearing optics described with reference to FIG. 2.

Beam forming optics, BF, are arranged to receive the diverging component beams and to form them onto a common path generally parallel to the optical z axis. The component beams then propagate via beam splitter and further illumination optics, I, to illuminate a substrate (measurement object) in the object plane D with the two (or more) parallel lines, or spots, as described elsewhere.

Light reflected from the substrate is coupled back to detection optics DO via beam splitter BS. From where it propagates to an imaging device such as the camera shown in FIG. 10 and/or appropriate phtotodetector and signal processor.

It will be appreciated the above simplified system may also be configured to create a pair of collimated beams that diverge from a point corresponding to Q in FIG. 2 (or in FIG. 11 described later) with the beam forming optics BF and other optics being arranged to modify the component beams as described with reference to FIG. 2 or FIG. 11.

It will be appreciated that, advantageously, rotation of the diffraction grating (or other such element) about an axis may be used to scan the resulting beams across the target of the measurement.

### Scanned Beam Optics

The optical configuration of the interferometer apparatus described with reference to FIG. 2 enables measurement to be made at a fixed point in the object. Another embodiment will now be described with reference to FIGS. 11 and 12, by way of example only, in which measurements may be made over a range of positions on the object.

FIG. 11 shows, generally at 90, another configuration of interferometer apparatus that may be used to enable the point of measurement, as defined by the centroid of the dual spot illumination, to be scanned over the measurement object thereby enabling measurements to be performed sequentially over a two dimensional (2D) surface. FIG. 12 shows part of the configuration shown in FIG. 11 and illustrates the scanning operation of that configuration.

The interferometer apparatus 90 of FIGS. 11 and 12 comprises a plurality of lenses L_{B1}, L_{B2} and L_{B3}, a beam splitter BS, and a ‘scanning’ mirror Mₛ.

Referring to FIG. 11 in particular, collimation optics (not shown) produce a beam of collimated light which is sheared, using one of the configurations of shearing optics (SO) described previously, to produce two component beams B1, B2 that each diverge at an angle ±α_{B} to the optical axis, from the shearing optics SO at common point Q, to the lens L_{B1}. From lens L_{B1}, the two component beams B1, B2 propagate, parallel to the optical z axis.

The lenses L_{B1} and L_{B2} have respective focal lengths f_{B1} and f_{B2}, and are arranged to have a shared focal plane through P_{B1} and P_{B2}. The two component beams B1, B2 travel via the focal points at P_{B1} and P_{B2}, each propagating in a direction parallel to the optical z axis with a separation of ±f_{B1}α_{B} relative to this axis (using the small angle approximation). The beam splitter BS is arranged such that the component beams B1, B2 from lens L_{B1} pass through it, essentially unhindered, to lens L_{B2}.

The lens L_{B2} and the scanning mirror Mₛ are arranged such that the rear focal plane image of the component beams B1 and B2 is incident on scanning mirror Mₛ. The mirror Mₛ is inclined at a variable angle to the optical axis although, in FIG. 11, it is shown at an angle of 45° to the optical axis which, in this embodiment, is its neutral position.

The image incident on the mirror Mₛ corresponds to a plane in which the collimated light from P_{B1} and P_{B2} overlap (as seen in more detail in FIG. 12). This results is two plane wavefronts centred at Q′ that diverge at an angle α_{B}′ (=f_{B2}α_{B}/f_{B1}) relative to an optical axis perpendicular to QQ′.

Lens L_{B3} is an ‘F/θ’ (also known as an ‘f/theta scanning’) lens centred on this axis perpendicular to QQ′, at its working distance d_{B3} relative to Q′. Lens L_{B3} transforms the incident plane wave front into two focal points P′_{B1} and P′_{B2} incident perpendicular to a surface of a measurement object placed in the focal plane of lens L_{B3} (at its focal length f_{B3}) and separated by a distance 2f_{B3}α_{B}′. Light reflected from the surface of this measurement object is coupled back to the detection optics via the scanning mirror Mₛ and the beam splitter BS placed between Lenses L_{B1} and L_{B2}.

In operation, therefore, the variation in the angle of the incidence on the scanning mirror Mₛ, in response to a time varying scan angle θ_{xy}(t), causes P′_{B1} and P′_{B2} to be either continuously or step scanned across the object over an area 2f_{B3}θₓ by 2f_{B3}θ_{y}.

Under these conditions phase measurement synchronous with the scan enables a 2D image of differential phase variation to be created, for example using the signal processing methods described earlier.

FIG. 13 shows another, simplified, method for providing a scanned beam, in a diffraction grating based system (although it could be used in other optical systems). In FIG. 13, the input optics are shown for a representative diffraction grating based system where the parallel input beam IB is diffracted into the +/−1 orders by the grating DG. The grating DG is placed in the input focal plane IF of a lens L_{G1}, focal length f_{G1}, so that the diffracted orders are focused perpendicular to the output focal plane OF. These beams may be translated in this plane by rotating a parallel sided optical flat P_{FLAT} by +/−θₛ about an axis, A, perpendicular to and centred on the optical axis between the output focal plane OF and lens L_{G1}. A beam scan +/−dₛ is shown, in the plane OF, that is the result of a lateral shift of the zero order beam (at 0) and diffracted beams (at +/−1) incident on the optical P_{FLAT} that results from the rotation of the optical flat P_{FLAT}. This linear scan is translated to the object plane by the remainder of the optics in the system as described elsewhere in this specification.

### Detection Optics

Whilst the detection optics configuration illustrated in and described with reference to FIG. 4 provides a particularly beneficial configuration in terms of the simplicity with which it provides the required imaging properties, the measurement techniques described for use with the detection optics of FIG. 4 require that, in the xz plane (FIG. 4(b)), the photo detector PD contains a near diffraction limited image of A, with as little distortion as possible. Conversely, in the yz plane, it is only necessary for substantially all of the light passing through the aperture A at a given y coordinate to be condensed onto the height of a pixel.

FIG. 14 shows another arrangement of the detection optics DO, which take advantage of the availability of high quality imaging lenses, to optimise the configuration of the optics. FIG. 14(a) shows the configuration in the yz plane and FIG. 14(b) shows the configuration in the xz plane.

As seen in FIG. 14, the detection optics DO comprise lenses L_{C4}, L_{C5} and L_{C6}.

Lens L_{C4} comprises a spherical lens and is arranged in a similar manner, relative to the object plane, as lens L₄ in FIG. 4. Lens L_{C5} is a diverging cylindrical lens arranged with conjugate points in the yx plane at the measurement object and at the aperture A at lens L_{C4} (i.e. at the focal distance of 6′ from lens L_{C5}). Lens L_{C5} causes the light incident on it to diverge in the yz plane but not in the xz plane.

Lens L_{C6} is a so called ‘well corrected’ multi-element imaging objective lens arranged to image A onto the photo detector PD, with the spherical lens L_{C4} gathering light onto it. The lens L_{C4} has a back focal distance l_{C4}′ equal to the front focal distance l_{C6} of lens L_{c6}. The lenses L_{C4} and L_{C6} and the photo detector PD are arranged such that lens L_{C4} is at a distance equal to l_{C4}′/l_{C6} from lens L_{C6} and photo detector PD is at a distance from lens L_{C6} that is equal to the rear focal distance l_{C6}′ of lens l_{C6}.

As seen in FIG. 14(a) lens L_{C6} is arranged to converge the light that it receives via lens L_{C5}, from aperture A onto the photo detector PD (e.g. a linear photo detector as described previously). The linear photo detector PD is arranged along the x axis, and the plane containing points P₁′ and P₂′ (FIG. 3 refers) is imaged onto the linear photo detector PD, along the x axis.

As seen in FIG. 14(b), the lenses L_{C4} and L_{C6} are arranged such that the object plane is imaged at L_{C6}, and the objective speckle pattern is imaged onto the photo detector PD, in the long axis of the linear photo detector.

Like FIG. 4, therefore, the resulting image A′ is an image of aperture A along the x axis, and of the object plane D in the y axis.

Whilst the detection optics configuration illustrated in and described with reference to FIG. 4 provides a particularly beneficial configuration in terms of the simplicity, the plano-convex cylindrical lens used to do the imaging of the objective speckle pattern can exhibit associated aberrations that limit performance through, e.g. distortion making a translation appear to be a translation plus stretch, instead of a pure translation. There are, however, many off-the-shelf spherical lenses which image without these aberrations. A configuration, such as that described above, which uses a spherical lens to image the objective speckle pattern can, therefore provide greater flexibility and improved results.

It will be appreciated that there are multiple possible detection optics configurations for detection optics which image the object plane at some point in front of the sensor (e.g. the plane of P₁″ and P₂″ as pictured in FIG. 4).

### Providing Additional Motion Sensitivity

It is also possible to provide additional motion sensitivity, compared to earlier examples, by providing a system which illuminates the object with more than one pair of spots, thereby providing sensitivity around other axes.

FIG. 15, for example, shows a four-spot interferometer system which can provide sensitivity to 5 degrees of motion.

In the system of FIG. 15, four spots of light are provided on the measurement object (e.g. using an appropriately adapted version of the optics described with reference to earlier figures).

The 4 different spot pairs are then spatially filtered (e.g. using suitably positioned beam splitters and slits) to pick out separated pairs of spots such that from each specific spot pair a different rotation and translation measurement may be derived.

Considering the spot pairs as labelled in FIG. 15, for example, we can calculate these 5 degrees of motion as follows:

θₓ=(θ₁₃+θ₂₄)/2

θ_{y}=(θ₁₂+θ₃₄)/2

θ_{z}=[(d₁₂−d₃₄)/Sₓ+(d₂₄−d₁₃)/S_{y}]/4

dₓ=(d₁₂+d₃₄)/2

d_{y}=(d₁₃+d₂₄)/2

Where:

θₘₙ signifies the rotation and dₘₙ signifies the translation as obtained from taking a measurement using spots Sm and Sn. θₓ, θ_{y}, and θ_{z} respectively signify the calculated rotation around the x, y and z axis dₓ, d_{y}, d_{z} respectively signify the translation in-the-direction-of the x, y and z axis.

### Linear Illumination

It will be appreciated that the scanned beam optics described with reference to FIGS. 11 and 12 enable measurements to be made at multiple locations. FIG. 16 illustrates a linear sensing scheme which allows measurements to be made, at multiple locations substantially simultaneously, in a specific practical application (measurement of variations in refractive index due to molecular surface binding). Specifically, FIGS. 16(a) and 16(b) respectively illustrate, a binding cell geometry and an associated line illumination geometry for use for performing measurements of molecular surface binding.

In the configuration of FIG. 16, two lines of illumination are imaged onto a measurement object as illustrated in FIG. 16(a) using apparatus similar to that described with reference to FIGS. 11 and 12 to generate sheared beam components D1 and D2 and project them on the surface of the measurement object. Measurements can be derived from the lines of illumination using detection optics similar to that illustrated in FIG. 4 or 14, or any suitable variation thereof, but using a two dimensional photo detector PD array (in the xy plane) as opposed to a linear detector (in the x direction only). Each row of the 2D photo detector can be processed in the same manner as for the linear detector, but with the y coordinate across the detector having a direct correspondence to the y coordinate at the object.

As will be described in more detail later with reference to a particular application in which this approach is particularly useful, in this configuration a number of sites on the object (B_{1,2 . . . n}) can be designated for inspection. These inspection sites B_{1,2 . . . n} may be compared not only to a local reference site (R_{1,2 . . . n}) but also to a neighbouring pair of reference sites (R_{11,12 . . . 1n}, R_{21,22 . . . 2n}). This allows for the effect of any bulk rotations of the substrate effectively to be removed.

Various other modifications will be apparent to those skilled in the art and will not be described in further detail here.

### Applications

It will be appreciated that the interferometer apparatus described herein has benefits in many applications. A number of these applications will now be described by way of example only.

The applications fall into two main areas: (a) the remote measurement of the motion of optically rough objects; and (b) the measurement of small variations in the refractive index due to molecular surface binding.

### Remote Motion Measurement

There is an established industrial requirement for differential vibration measurement, e.g. in the field of automotive component testing. Currently this requirement is addressed using an approach that requires two separate measurements from two locations (typically each using laser Doppler vibrometry) and compares these.

In contrast using the interferometer apparatus described herein, an interference pattern is created between the returned light from two locations, and capture the differential motion from single measurement, as described above. As well as simplifying the measurement, this also removes the effect of many confounding factors and significantly improves measurement accuracy.

In addition to differential vibrations, the apparatus and methods described herein allows measurement of any translational motions of the object being measured.

Whilst devices which can track the translations of moving objects are available commercially, these require a specific target (e.g. retro-reflective prism) for tracking, whereas the apparatus and methods described herein allow measurement of the motion of any rough surface, using the laser speckle from the surface roughness as a reference.

In combination the apparatus and methods described herein enables a single motion measurement system capable of measuring differential vibration around two axes, macroscopic translations in a plane normal to the optical axis, and rotations around the optical axis. It will be appreciated that the measurement capability could be further extended to provide the addition of accurate distance measurement (e.g. using time-of-flight) to enable remote measurement of the full 6 degrees-of-motion (using the apparatus of FIG. 15).

Such a system can measure distances up to 10s of meters or even greater subject to laser safety imposed limitations.

### General Concept

The general concept for measurement of molecular surface binding is illustrated in FIGS. 16 to 18.

FIGS. 16(a) and 16(b) respectively illustrate, a binding cell geometry and an associated line illumination geometry for use for performing measurements of molecular surface binding.

FIGS. 17(a) and 17(b) respectively illustrate illumination, for the purposes of performing label free binding measurements, of: (a) a flow cell in a reference state in which there is no surface binding; and (b) a flow cell in a bound state in which there is surface binding.

In the unbound state (FIG. 17(a)) the beams D1 and D2 are incident on a binding site B and reference site R respectively (e.g. at a binding site B_{1,2 . . . n} and associated reference site R_{1,2 . . . n} shown in FIG. 16(a) where the scanning configuration of FIGS. 11 and 12 is used) on the internal face of an optically transparent substrate S that forms part of a flow cell FC.

Referring to FIG. 17(b), in operation fluid containing molecules M is passed through the flow cell. Molecules with appropriate affinity become bound to the binding sites B resulting in the formulation of a cavity of thickness t at the substrate local to this site. This increases the optical path length of component beam D1 relative to component beam D2 by 2n_{b}t where the cavity thickness t will depend on the extent of the binding and n_{b} is the refractive index of the bound molecules. The resultant phase shift of beam D1 relative to beam 2 (=4πn_{b}t/λ) is measured by the interferometer.

For this application a scanned configuration of interferometer, similar to that described with reference to FIGS. 11 and 12, is preferred because this has normal surface illumination and may be extended for measurement at multiple sites using the scan mechanism. In such a system, for example, the binding site element (such as the flow cell FC) is placed in the object plane D shown in FIG. 11.

FIG. 18 shows an interferometer apparatus, for performing label free binding measurements, that incorporates a scanned configuration, similar to that described with reference to FIGS. 11 and 12, generally at 150. In the interferometer apparatus 150 shown in FIG. 18 a binding site element of a flow cell FC is located in the object plane D.

A set of binding sites B and reference sites R, in the binding cell configuration shown in FIG. 16, are illuminated by respective lines of illumination from component beams D1 and D2, as shown in insert 15 a. The shearing optics, SO, operate as previously described, sending a pair of sheared, collimated beams to the elements lens L_{D2}, lens L_{D3}, mirror Mₛ and lens L_{D4}, which operate in a scanning configuration similar to that shown in FIG. 11, although lens L_{D4} in this example is a cylindrical lens configured to produce a line focus. The lines of illumination are measured, using detection optics DO which receive illumination returned from the flow cell via beam splitter B₂. DO, in this example, consists of two perpendicular cylindrical lenses: lens L_{D5} which is configured to image the object plane, D, onto a 2D photo detector PD in the y-axis; and lens LD6 which is configured such that, in the x-axis, the PD is in the Fourier plane of the reimaged lines at D′. The detection optics produce interference patterns corresponding to each binding site B_{1,2 . . . n} and associated reference site (and corresponding to each neighbouring pair of reference sites R_{11,12 . . . 1n}, R_{21,22 . . . 2n}) at the 2D photo detector, as shown in insert 15b. The fringes in these patterns move in dependence on relative changes of refractive index at the binding site due to the associated phase changes.

The patterns corresponding to each binding site B_{1,2 . . . n} and associated reference site R_{1,2 . . . n} will also vary with changes in phase associated with bulk rotations of the measurement object. However, because the pattern for the neighbouring pair of reference sites R_{11,12 . . . 1n}, R_{21,22 . . . 2n} will also exhibit this phase change (but will not exhibit changes due to changes in refractive index), the effect of bulk rotations can be eliminated by comparing the variation in pattern associated with each binding site B_{1,2 . . . n} and associated reference site R_{1,2 . . . n} with any variation in the pattern associated with the neighbouring pair of reference sites R_{11,12 . . . 1n}, R_{21,22 . . . 2n}.

### Surface Plasmon Resonance (SPR)

FIGS. 19 and 20 each illustrates a configuration for using a dual spot configuration, as described previously, in conjunction with a surface plasmon resonance (SPR) illumination geometry for ultra-high sensitivity, phase domain label free detection.

In each of FIGS. 19 and 20 a prism 160, 170 is provided having a resonant surface GS (in these examples, the resonant surface GS is a gold surface of a given thickness) in a manner suitable for conventional SPR as those skilled in the art would readily understand. In operation, the prism 160, 170, may be arranged on a flow cell for which the molecular binding measurements are to be performed.

A pair of parallel component beams E1 and E2, F1 and F2 are produced via the shearing optics SO (e.g. from a collimated beam generated from an illumination source using an optical configuration described previously). The component beams E1, E2, F1, F2 are directed through prism 160, 170 to illuminate the resonant surface GS, that is provided on the face ‘ab’ of the prism 160, 170 via a lens L_{E3}, L_{F3}, at an angle β to the normal of the gold surface GS. The apparatus is arranged such that the angle β corresponds to the angle required for resonant interaction with the given gold coating thickness.

In the apparatus of FIG. 19, the component beams E1, E2 as reflected by the resonant surface GS are received and detected by detection optics DO that are separate from the shearing optics SO. Contrastingly, in the apparatus of FIG. 20, the component beams F1, F2 as reflected by the resonant surface GS are incident on a mirror M arranged to reflect the component beams back towards the resonant surface GS and, ultimately, detection optics DO which are combined, in a single optics configuration with the shearing optics SO.

The differential phase between the component beams, resulting from the effective lengthening of one component beam relative to the other associated with binding at different sites within the resonant surface GS, can then be measured at the detection optics DO as described previously.

The configurations shown in FIGS. 19 and 20 may each be operated in a scanned mode by taking into account the fact that the beam waist at P₁ and P₂ must accommodate the varying ratio of glass to air and depth of field required for the nominally 45° angle of incidence as the beam is scanned. Specifically, referring to FIG. 19, if the spots are scanned along the line of the prism surface ab, whilst keeping the beam at 45° to the line of the prism surface ab, then the light has to travel through more glass to get to the object plane at b than it does at a, meaning that the light comes into focus too soon. Accordingly, in the configurations shown in FIGS. 19 and 20, the spots are provided with a large enough depth of field to be sufficiently in focus at the object at both ends of the scan. This problem may also be mitigated, for extended fields of view, by translation of the prism and/or the optics in a direction PQ parallel to the prism surface ab, whilst maintaining the angle β at the required resonant angle.

### Flow Cytometer Configurations

FIGS. 21 and 22 each illustrate how the interferometer described herein may be adapted for application in interferometric flow cytometry for transmissive and reflective measurement respectively.

In arrangements of FIGS. 21 and 22, focal points P_{G1}′ and P_{G2}′, P_{H1}′ and P_{H2}′ are formed at the centre of a flow cell FC through which optically transparent particle Q of radius r_{q} and refractive index n_{q} are carried at a flow velocity v_{f} parallel to the x axis by an optically transparent fluid of refractive index n_{f}.

FIG. 23 illustrates, in simplified form, the basic interferometer output that results from the passage of the particle Q through the focal points P_{G1}′ and P_{G2}′, P_{H1}′ and P_{H2}′ (provided the particle diameter 2r_{q} is less than the beam separation).

In FIG. 23, the signal is correlated with the position of the particle at the specific positions p₁ to p₆.

When it is assumed, for simplicity, that the interfering beams P_{G1}′ and P_{G2}′ or P_{H1}′ and P_{H2}′ have the same intensity I₁₂=I₁=I₂ then the intensity of the two beam interference is I_{d}(t) is given by:

I_{d}(t)=2I₁₂(1+cos(φ_{q}+Δφ_{q})) (11)

where φ_{q} is the phase of the fringe field at the detector in absence of a transiting particle, and Δφ_{q} is the phase change generated by the particle transition, i.e.:

$$Δ {φ}_{q} = \frac{N π {r}_{q} ( {n}_{q} - {n}_{f} )}{λ} \qquad ( 12 )$$

for r_{q}>wₚ, and:

$$Δ {φ}_{q} = \frac{N π {r}_{q}^{3} ( {n}_{q} - {n}_{f} )}{{λ w}_{{P}^{′}}^{2}} \qquad ( 13 )$$

otherwise.

In both cases N=2 for transmission, N=4 for reflection.

If we chose φ_{q}≈π/2 then equation 11 reduces to the form

I_{d}(t)=I_{O}+KΔφ_{q} (14)

where

I_{O}=2I₁₂(1+φ_{q}−^{π}/₂)

K=2I₁₂

Hence,

$$Δ {φ}_{q} = \frac{{I}_{d} ( t ) - {I}_{o}}{K} \qquad ( 15 )$$

Equation 14 defines the time varying interference signal l_{d}(t) shown in FIG. 23 and is a combined function of the particle size r_{q} and refraction index n_{q}. If the flow velocity v_{f} is known, then the particle size may be determined from separation in time Δtₙₘ=tₘ−tₙ between the signals observed at the particle position at various combinations of position:

$${r}_{p} = \frac{{V}_{f} Δ {t}_{13}}{2} - {w}_{{p}^{′}} = \frac{{V}_{f} Δ {t}_{46}}{2} - {w}_{{p}^{′}} = {s}_{x}^{′} - ( \frac{{V}_{f} Δ {t}_{34}}{2} + {w}_{{p}^{′}} ) = 2 {s}_{x}^{′ } - Δ {t}_{25} {v}_{f} \qquad ( 16 )$$

It will also be recognised from the above analysis that the signal l_{d}(t) defines the convolution between the particle size as defined by its refractive index profile and the P_{G1}′ and P_{G2}′ or P_{H1}′ and P_{H2}′ illumination structure. Analysis of the detected interference signal l_{d}(t) based on the above and in accordance with equations 12, 14 and 15 thereby provides a means by which the particle size and refractive analysis may be measured effectively.

### Virtual Flow Cell for Flow Cytometer Configurations

The sensitivity of the phase variation (equation 15) to the presence of a particle decreases to zero as the result of the transition from the region of dual beam focus to beam overlap.

Another application of the interferometer apparatus, illustrated in FIG. 24 makes beneficial use of this phenomenon to define a ‘virtual’ flow cell.

Specifically, the volume represented by the sensitive dual beam focus region defined by the transitional interface with the beam overlap region can be treated as an effective flow cell in a larger volume of fluid (e.g. fluid which is substantially unconstrained). It can be seen that this virtual flow is equivalent to, and can thus be used in a similar manner to, the ‘real’ flow cells of FIGS. 21 and 22 to measure the characteristics of particles flowing in the fluid in accordance with the techniques described above. Advantageously, therefore, under these conditions, measurements may be performed remotely, over short to long ranges, for particles in an open fluid.

### Intra Fluid Refractive Index Variation

The above ‘virtual flow cell’ principle may be extended further to the measurement of the differential refractive index of a fluid within the virtual sensitive volume. This enables, for example, the presence of a fluid with a temporal and spatial variation in refractive index to be detected relative to a nominally uniform background. A potential application for this advantageous configuration is remote, non-contact leak detection.

### Summary of Biological Applications of Surface Binding Measurement

A number of specific applications in which the surface binding measurement, using the interferometric apparatus described herein, may be used in specific applications will now be described by way of example only.

### Nucleic Acid Testing

Immobilised, sequence specific probes for nucleic acid can be arranged at defined locations to act as bait for specific nucleic acids. Following the exposure of nucleic acids to these probes the binding of specific nucleic acids can be quantified by examination using the interferometer apparatus and/or interferometry methods described herein.

### Protein Testing

Immobilised, sequence specific probes for protein can be arranged at defined locations to act as bait for specific proteins. Following the exposure of proteins, or parts of proteins to these probes the binding of specific proteins can be quantified by examination using the interferometer apparatus and/or interferometry methods described herein. This could be used to evaluate the protein content of a sample which is being analysed on the array or the affinity of different probes to specific proteins.

### Evaluation of Proteins and Nucleic Acids on a Single Array

Immobilised, sequence specific probes for proteins and nucleic acids can be arranged at defined locations to act as bait for nucleic acids and proteins in the same sample; enabling both proteins and nucleic acids to be evaluated at the same time from the same sample. Following the exposure of nucleic acids and proteins to the probes the binding of specific nucleic acids and proteins can be quantified by examination using the interferometer apparatus and/or interferometry methods described herein.

### Cell Evaluation

Whole cells or fragments of cells could be captured on an immobilised array of probes which are arranged at defined locations to act as bait for specific cells or fragments of cells. The binding of cells or fragments of cells can then be quantified by examination using the interferometer apparatus and/or interferometry methods described herein.

### Digital Nucleic Acid Testing

Following the creation of an emulation in which nucleic acids are associated with beads which have specific nucleic acids attached to their surface, the nucleic acids are amplified using DNA amplification enzymes (requiring either thermal cycling or isothermal amplification). The resultant increase in mass on the surface of the bead can be identified using the interferometer apparatus and/or interferometry methods described herein. The bead size and composition can also vary to enable the identification of multiple different nucleic acid species from the same sample.

### Performance of Prototype Systems

Laboratory prototypes of the interferometer apparatus were built and tested.

For apparatus using an intrinsically noise insensitive diffraction grating as the shearing optics SO, the noise equivalent displacement was found to be in the range 1 to 15 picometres dependent on measurement mode. This corresponds to a limiting molecular loading resolution of approximately ˜0.1-1.5 ng/cm² and represents an improvement relative to a 100 picometre noise floor achievable using a Michelson interferometer based shearing optics SO with additional benefits in terms of simplicity and cost.

The performance exhibited by the interferometer apparatus were compatible with that required for label free binding detection.

The interferometer apparatus therefore provides an advantageous method for a number of applications including label free binding detection.

The interferometer apparatus provides benefits in terms of simplicity by allowing, for example, a planar glass binding substrate to be used without the need for optical structures such as Fabry Perot, grating arrays and wave guides used in known techniques.

The interferometer apparatus provides benefits in terms of cost with the ability to use standard ‘off-the-shelf’ components are used throughout.

The interferometer apparatus provides benefits in terms of flexibility with the apparatus being configurable for a number of applications including either substrate or flow cytometric binding detection.

The interferometer apparatus provides benefits in terms of surface plasmon resonance (SPR) compatibility with the apparatus being configurable for interferometric SPR measurement thereby providing a route to ultra-high sensitivity measurement (<˜0.001 ng/cm²).

FIGS. 25 and 26 illustrate the results of an experiment to determine noise limited resolution of the apparatus.

FIG. 25 shows a plot of the changes in measured optical path length over time, for two different illuminated sites and FIG. 26 shows a plot of the differences between the measured optical path length for the two sites of FIG. 24.

In the experiment, measurement was made for two separate ˜100 μm locations on a flat substrate (1:1 mark:space).

As can be seen in FIG. 25, at a given site the overall signal is dominated by vibrations of the bench on which the apparatus was configured. Nevertheless, the dominant vibrations are relatively low frequency—of the order of Hz—by virtue of appropriate damping.

As seen in FIG. 25, however, there is very little difference between the low frequency vibrations at the two sites (making it very difficult to distinguish between the two plots shown on FIG. 25). Thus, by taking the difference between the two sites the effect of the low frequency vibration can, in effect, be substantially eliminated.

The difference between the two sites is illustrated in FIG. 26 in which the root-mean-square (RMS) error between subsequent measurements (for a 70 Hz sample rate, and 50 sensor rows per site) is approximately 15 picometres.

Thus, the performance of the apparatus is shot-noise limited (physical limit on performance) for frequencies greater than approximately 1 Hz with a picometer order resolution achievable for rapidly changing phenomena (e.g. flow cytometry).

1. Optical apparatus for measuring characteristics of a measurement target, the apparatus comprising an illumination portion and, detection portion and a processing portion:
the illumination portion comprising:
means for producing at least one pair of spatially separated areas of illumination for illuminating said measurement target to produce an associated light field from which said characteristics of said measurement target can be measured, wherein the areas of illumination are mutually coherent and are each provided via a substantially common path such that the light field produced by the illumination of the measurement target comprises:
a plurality of components having an increased power at spatial frequencies corresponding to interference between said areas of illumination;
wherein said means for producing at least one pair of spatially separated areas of illumination is operable to:
illuminate a first site on the measurement target with at least one of said spatially separated areas of illumination; and
illuminate a second site on the measurement target with at least one other of said spatially separated areas of illumination;
the detection portion comprising:
means for detecting light and for outputting signals dependent on the intensity of the detected light;
means for receiving said light field from the measurement target resulting from said illumination of the measurement target with the at least one pair of said spatially separated areas of illumination, the light field resulting from each pair containing said plurality of components having an increased power at spatial frequencies corresponding to interference between said areas of illumination;
means for directing the received light field onto the light detecting means;
the processing portion comprising:
means for analysing said signals output by said detecting means to measure said characteristics of said measurement target, wherein said analysing means is operable to analyse said signals output by said detecting means, in the frequency domain, to determine changes in said components having an increased power and to measure a difference between a first phase of at least one of said areas of illumination and a second phase for another of said areas of illumination based on said determined changes in said components having an increased power.

2. Optical apparatus as claimed in claim 1 wherein said means for producing the at least one pair of spatially separated areas of illumination comprise shearing optics for shearing an incoming beam of light into at least two sheared beams of mutually coherent light, each sheared beam representing a respective source of one of said spatially separated areas of illumination.

3. Optical apparatus as claimed in claim 2 further comprising optics for transforming said at least two sheared beams into at least two parallel beams each parallel beam representing a respective source of one of said spatially separated areas of illumination.

4. Optical apparatus as claimed in claim 2 or 3 wherein said shearing optics comprises a non-interferometric component for shearing the incoming beam.

5. Optical apparatus as claimed in any of claims 2 to 4 wherein said shearing optics comprise a diffraction grating for shearing the incoming beam.

6. Optical apparatus as claimed in any of claims 1 to 4 wherein said analysing means is operable to analyse said signals output by said detecting means to measure characteristics of said measurement target associated with an effective difference between an optical path length for at least one of said areas of illumination and an optical path length for another of said areas of illumination.

7. Optical apparatus as claimed in claim 6 wherein said analysing means is operable to analyse said signals output by said detecting means to measure characteristics comprising a rotation of said measurement target to cause said effective difference between an optical path length for at least one of said areas of illumination and an optical path length for the other of said areas of illumination.

8. Optical apparatus as claimed in any of claims 1 to 7 wherein said means for producing spatially separated areas of illumination is operable to illuminate a measurement target with at least three spatially separated areas of illumination, wherein said at least three spatially separated areas of illumination are arranged to allow measurement for the measurement target to be performed for each of at least two axis of rotation.

9. Optical apparatus as claimed in claim 8 wherein said detection portion comprises means for spatially filtering said light field associated with said at least three spatially separated areas of illumination to produce a light field associated with two of said separated areas of illumination whereby to select an axis of rotation for which measurement is to be performed.

10. Optical apparatus as claimed in claim 9 wherein said analysing means is operable to analyse said signals output by said detecting means to measure characteristics comprising a rotation said measurement target about said selected axis.

11. Optical apparatus as claimed in any of claims 1 to 10 wherein said detecting means comprises a point detector.

12. Optical apparatus as claimed in claim 11 further comprising means for modulating phase of at least one of said spatially separated areas of illumination, using a known phase modulation, whereby to allow said analysing means to determine differences in phase associated with characteristics of said measurement target by analysing phased with reference to said known phase modulation.

13. Optical apparatus as claimed in any of claims 1 to 10 wherein said detecting means comprises a one dimensional detector (e.g. a linear detector or linear array detector).

14. Optical apparatus as claimed in any of claims 1 to 10 wherein said detecting means comprises a two dimensional detector.

15. Optical apparatus as claimed in any of claims 1 to 14 wherein said means for producing at least one pair of spatially separated areas of illumination is operable to provide said spatially separated areas of illumination as two spots of illumination on a surface of a measurement target.

16. Optical apparatus as claimed in any of claims 1 to 14 wherein said means for producing at least one pair of spatially separated areas of illumination is operable to provide said spatially separated areas of illumination as two lines of illumination.

17. Optical apparatus as claimed in claim 16 wherein said analysing means is operable to analyse respective signals output by said detecting means for each of a plurality of different parts of said lines of illumination, whereby to measure characteristics of said measurement target at a plurality of different locations, each location being associated with a different respective part of said lines of illumination.

18. Optical apparatus as claimed in any of claims 1 to 17 wherein said means for producing at least one pair of spatially separated areas of illumination comprises means for scanning the spatially separated areas of illumination across a measurement target (e.g. without moving the apparatus from one location to another).

19. Optical apparatus as claimed in claim 18 wherein said scanning means comprises at least one mirror.

20. Optical apparatus as claimed in claim 18 or 19 wherein said scanning means comprises at least one scanning lens (e.g. an F over theta lens).

21. Optical apparatus as claimed in claim 18 wherein said scanning means comprises at least one optical flat.

22. Optical apparatus as claimed in any of claims 1 to 21 wherein said analysing means is operable to analyse said signals output by said detecting means to measure characteristics of said measurement target associated with an effective difference between: an optical path length for the at least one area of illumination illuminating said first site; and an optical path length for the at least one other area of illumination illuminating said second site.

23. Optical apparatus as claimed in any of claims 1 to 22 wherein said analysing means is operable to analyse said signals output by said detecting means to measure characteristics, of said measurement target, associated with molecular surface binding at the first site.

24. Optical apparatus as claimed in claim 23 wherein said analysing means is operable to analyse said signals output by said detecting means to measure characteristics, of said measurement target, associated with the occurrence of binding events associated with a change in optical path length.

25. Optical apparatus as claimed in claim 24 wherein said analysing means is operable to analyse said signals output by said detecting means to measure characteristics, of said measurement target, associated with the occurrence of binding events associated with an increase in optical path length.

26. Optical apparatus as claimed in claim 24 wherein said analysing means is operable to analyse said signals output by said detecting means to measure characteristics, of said measurement target, associated with the occurrence of binding events associated with a decrease in optical path length.

27. Optical apparatus as claimed in any of claims 23 to 25 wherein said means for producing at least one pair of spatially separated areas of illumination is operable to illuminate at least two further sites on the measurement target with at least one further pair of spatially separated areas of illumination; wherein said analysing means is operable to analyse said signals output by said detecting means for illumination incident on said at least two further sites to measure characteristics, of said measurement target, associated with rotation of said measurement target; and wherein said analysing means is operable to use said measured characteristics associated with rotation of said measurement target to mitigate the effect of said rotation said measures characteristics associated with molecular surface binding.

28. Optical apparatus as claimed in any of claims 1 to 25 further arranged for inducing surface plasmon resonance while performing said measurement.

29. Optical apparatus as claimed in any of claims 1 to 28 wherein said measurement target is located in an optically transparent medium (e.g. a medium having a refractive index greater than or equal to 1, e.g. a transparent fluid or liquid) and said illumination and detection portions are provided on either side of said optically transparent medium.

30. Optical apparatus as claimed in any of claims 1 to 28 wherein said measurement target is located in an optically transparent medium (e.g. a medium having a refractive index greater than or equal to 1) and said illumination and detection portions are provided on the same side of said optically transparent medium.

31. Optical apparatus as claimed in claim 29 or 30 wherein said measurement target is optically transparent having a refractive index that is different to said refractive index of said transparent medium.

32. Optical apparatus as claimed in claim 31 wherein said analysing means is operable to measure characteristics of said measurement target based on differences in phase associated with differences in said refractive indexes.

33. Optical apparatus as claimed in any of claims 29 to 32 wherein said analysing means is operable to measure characteristics of a measurement target comprising a particle flowing in said transparent medium, past said areas of illumination, the characteristics comprising a size of said particle

34. Optical apparatus as claimed in claim 33 wherein said analysing means is operable to measure characteristics of said particle, when said particle is flowing within a region of said transparent medium, wherein said region is a region of focus for a plurality of beams within said transparent medium, each beam representing a respective source of one of said spatially separated areas of illumination.

35. Optical apparatus as claimed in any of claims 29 to 34 wherein said measurement target comprises part of said transparent medium having a characteristic (e.g. refractive index) that varies with respect to a corresponding characteristic of another part of said transparent medium and wherein said analysing means is operable to measure said characteristic that varies with respect to a corresponding characteristic of another part of said transparent medium, wherein said part of said transparent medium having a characteristic that varies with respect to a corresponding characteristic of another part of said transparent medium region is part of a region of focus for a plurality of beams within said transparent medium, each beam representing a respective source of one of said spatially separated areas of illumination.

36. Optical apparatus as claimed in any of claims 1 to 35 wherein the means for producing at least one pair of spatially separated areas of illumination is configured for illuminating an optically rough surface of said measurement target, wherein the areas of illumination are each provided such that the light field produced by the illumination of the measurement target further comprises a component associated with self-interference within at least one of said areas of illumination; and wherein the plurality of components having an increased power at spatial frequencies corresponding to interference between said areas of illumination are separable from the component comprising interference associated with self-interference.

37. Optical apparatus as claimed claim 36 wherein said analysing means is operable to discriminate between said components corresponding to interference between said areas of illumination and said component comprising self-interference associated with roughness of said optically rough surface, whereby to measure said characteristics of said measurement target.

38. Optical apparatus as claimed in claim 37 wherein said analysing means is operable to analyse said self-interference associated with roughness of said optically rough surface to measure said characteristics of said measurement target.

39. Optical apparatus as claimed in claim 38 wherein said analysing means is operable to analyse said self-interference associated with roughness of said optically rough surface to measure characteristics of said measurement target associated with a movement of said illuminated measurement target (e.g. a translational movement in the plane of said illumination).

40. Optical apparatus as claimed in claim 39 wherein said analysing means is operable to analyse said self-interference associated with roughness of said optically rough surface to measure characteristics of said measurement target associated with a movement, of said illuminated measurement target, with components in either or both of two axial directions within the plane of the surface.

41. Optical apparatus as claimed in claim 40 wherein said analysing means is operable to analyse said self-interference associated with roughness of said optically rough surface to measure characteristics of said measurement target associated with a rotational movement, of said illuminated measurement target, about an axis normal to the plane of the surface based on measurements of differential translations at two separate locations.

42. Illumination apparatus for use as said illumination portion of the optical apparatus of any of claims 1 to 41, the illumination apparatus comprising: said means for producing at least one pair of spatially separated areas of illumination for use in measuring said characteristics of said measurement target, wherein the areas of illumination are mutually coherent and are each provided via a substantially common path.

43. Detection apparatus for use as said detection portion, of the optical apparatus of claims 1 to 41, the detection apparatus comprising: said means for detecting light and for outputting a signal dependent on the intensity of the detected light; said means for receiving a light field from the measurement target resulting from illumination of the measurement target with at least one of said spatially separated areas of illumination; and said means for directing the received light field onto the light detecting means.

44. Signal processing apparatus for use as said processing portion, of the optical apparatus of claims 1 to 41, the signal processing apparatus comprising said means for analysing said signals output by said detecting means to measure said characteristics of said measurement target.

45. A method performed by optical apparatus for measuring characteristics of a measurement target, the apparatus comprising an illumination portion and, detection portion and a processing portion, the method comprising:
the illumination portion:
producing at least one pair of spatially separated areas of illumination for illuminating said measurement target to produce an associated light field from which said characteristics of said measurement target can be measured, wherein the areas of illumination are mutually coherent and are each provided via a substantially common path such that the light field produced by the illumination of the measurement target comprises:
a plurality of components having an increased power at spatial frequencies corresponding to interference between said areas of illumination;
wherein said at least one pair of spatially separated areas of illumination:
illuminates a first site on the measurement target with at least one of said spatially separated areas of illumination; and
illuminates a second site on the measurement target with at least one other of said spatially separated areas of illumination;
the detection portion:
receiving said light field from the measurement target resulting from said illumination of the measurement target with the at least one pair of said spatially separated areas of illumination, the light field resulting from each pair containing at least said component corresponding to interference between said areas of illumination; directing the received light field onto light detecting means;
detecting light at the detecting means and outputting signals dependent on the intensity of the detected light;
the processing portion:
analysing said signals output by said detecting means to measure said characteristics of said measurement target, wherein said analysing comprises analysing said signals output by said detection portion, in the frequency domain, to determine changes in said components having an increased power and to measure a difference between a first phase of at least one of said areas of illumination and a second phase for another of said areas of illumination based on said determined changes in said components having an increased power.

46. A method performed by illumination apparatus, the method comprising: producing at least one pair of spatially separated areas of illumination for illuminating a measurement target to produce an associated light field from which said characteristics of said measurement target can be measured, wherein the areas of illumination are mutually coherent and are each provided via a substantially common path such that the light field produced by the illumination of the measurement target comprises: a plurality of components having an increased power at spatial frequencies corresponding to interference between said areas of illumination; wherein said producing at least one pair of spatially separated areas of illumination comprises: illuminating a first site on the measurement target with at least one of said spatially separated areas of illumination; and illuminating a second site on the measurement target with at least one other of said spatially separated areas of illumination; wherein a change in said components having an increased power results in a corresponding change in a difference between a first phase of at least one of said areas of illumination and a second phase for another of said areas of illumination.

47. A method performed by detection apparatus for detecting a light field produced using the method of claim 46, the method performed by the detection apparatus comprising: receiving said light field from the measurement target resulting from said illumination of the measurement target with the at least one pair of said spatially separated areas of illumination, the light field resulting from each pair containing at least said plurality of components component having an increased power at spatial frequencies corresponding to interference between said areas of illumination.

48. A method performed by signal processing apparatus for processing signals output by as part of the method of claim 47, the method performed by signal processing apparatus comprising: analysing said signals output by said detecting apparatus to measure said characteristics of said measurement target, wherein said analysing comprises analysing said signals output by said detection apparatus, in the frequency domain, to determine changes in said components having an increased power and to measure a difference between a first phase of at least one of said areas of illumination and a second phase for another of said areas of illumination based on said determined changes in said components having an increased power.
